(19) United States
(12) Patent Application Publication
(10) Pub. No.: US 2004/0156322 A1
(43) Pub. Date: Aug. 12, 2004

(54) Network and method of configuring a network

(76) Inventor: Pankaj Mehra, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/722,180

(22) Filed: Nov. 24, 2003

Related U.S. Application Data
(63) Continuation-in-part of application No. 10/291,865, filed on Nov. 7, 2002.
(60) Provisional application No. 60/393,936, filed on Jul. 2, 2002.

(51) Int. Cl. H04L 12/28

(52) U.S. Cl. 370/254

(57) ABSTRACT

An exemplary method for configuring a network may comprise assigning a plurality of first nodes as a balanced incomplete block design of the form 2-(ν, k, 1)=b, wherein ν first nodes, arranged in b groups of k first nodes, are interconnected such that a pair of first nodes appears in only one group of the b groups. The method also comprises assigning a plurality of sets of second nodes wherein each first node is associated with at least one set of second nodes, and determining network paths from each second node of the plurality of sets of second nodes to every other second node.

### REFERENCE TO RELATED APPLICATIONS

This application is a Continuation-in-Part (CIP) of U.S. Non-Provisional application Ser. No. 10/291,865 entitled “Method And Apparatus for Cluster Interconnection Using Multi-Port Nodes and Multiple Routing Fabrics,” filed Nov. 7, 2002 and claims the benefit of U.S. Provisional Application 60/393,936 filed Jul. 2, 2002, which applications are incorporated herein by reference.

### BACKGROUND

In modern computer systems, much of their functionality is realized by the ability to network, that is connect, various computers to provide digital communication. Indeed many interconnection schemes have been developed that meet interconnection needs in various ways. For example, multiprocessor systems can be configured as bus-connected or ring-connected multiprocessor systems. The operation and design constraints of such systems, however, do not lead to designs for reliable and scalable switched networks, especially ones that implement crossbar switches employing wormhole routing. The primary limitation of this type of configuration is that ring topologies are not suitable for wormhole-routed switched networks and result in an unacceptably large hop count between end nodes or endpoints as the network is scaled.

In another example, the design of bus-oriented interconnection topologies for single-hop communication among multiple transceiver stations is not applicable to scalable switched networks because, among other things, a single-hop interconnection between a large number of nodes is impossible when crossbar switches with a limited number of ports are used. Moreover, such designs use bus-based interconnects which bear little resemblance, if any, to switched interconnects.

Non-bus-oriented single-hop interconnections are also deficient in a number of ways. For example, such configurations suffer the same limitations as described above while also connecting nodes (or switchless networks) directly. This latter feature limits the applicability of the design to end nodes having a large number of ports and to fabrics having zero switches and hence is inapplicable to the design of switched interconnects.

In a traditional approach, ServerNet networks have been designed with two ports, also called “colored” ports or “X” and “Y” ports, connected to two complete, independent groups of crossbar switches. The interconnection group is complete because every end node interfaces with each group of crossbar switches and each group of switches interfaces with every node. Moreover, the interconnection group is independent because ports of one type are only connected to other ports of the same type. For example, each of the X ports is only connected via an X fabric to other X ports and each of the Y ports in the network is likewise only connected via a Y fabric to other Y ports. Note here that an X fabric is a group of switches that connect all the X ports and only the X ports in the network (similarly for Y ports). In this way, a fabric of one type is designed independently of other fabrics of other types.

A particular concern in network design is fault tolerance. With a large scaled system there is insufficient protection against single points of failure because of the large number of components, and it is hard to maintain symmetry because of failed parts. Moreover, scalable topologies (e.g. fat trees) offer design points exponentially far apart. In addition, the relative capacity of an end node shrinks as a network grows in size.

One improved approach has introduced ServerNet Asymmetric Fabrics. With this approach, end nodes are connected using two complete but non-identical groups of switches. Namely, network expansion requires scalable switched networks. The issue, however, is scalable yet highly available fabrics. Hence, there is a further need for optimizing the reliability and performance of scalable switched networks.

Existing solutions in the area of bus-connected and ring-connected multi-computer systems do not lead to designs for scalable and reliable switched networks because of the operation and design constraints of such solutions. This is especially true in networks configured for use with crossbar switches employing wormhole routing. Moreover, such solutions do not address how a network comprising multiple incomplete fabrics can simultaneously optimize the reliability and the performance of scalable switched networks.

While the above interconnection schemes provide certain functionality, they are nonetheless limited in at least the ways discussed above. With the advent of network interface cards and other similar devices that provide for multiple ports on one computer system, network design can be expanded beyond the constraints of prior art systems. Importantly, interconnection fabrics need not be constrained to being complete nor colored. Notably, interconnection fabrics should be allowed to be incomplete while allowing for improved fault tolerance and reduced hardware resources. Toward finding an optimal design, however, there exists a need to determine the bounds on various parameters of network designs.

### SUMMARY

An exemplary embodiment may comprise a method for configuring a network. The method comprises assigning a plurality of first nodes as a balanced incomplete block design of the form 2-(ν, k, 1)=b, wherein ν first nodes, arranged in b groups of k first nodes, are interconnected such that a pair of first nodes appears in only one group of the b groups. The method also comprises assigning a plurality of sets of second nodes wherein each first node is associated with at least one set of second nodes, and determining network paths from each second node of the plurality of sets of second nodes to every other second node.

### BRIEF DESCRIPTION OF THE DRAWINGS

The accompanying drawings, which are incorporated in and form a part of this specification, illustrate exemplary embodiments and, together with the description, serve to explain the principles of the present disclosure.

FIG. 1 is a network diagram according to an exemplary embodiment for interconnecting seven elements each with three ports.

FIG. 2 is a network diagram according to an exemplary embodiment for interconnecting three elements using three fabrics.

FIG. 3 is a network diagram according to an exemplary embodiment for interconnecting four elements using six fabrics.

FIG. 4 is a network diagram according to an exemplary embodiment for interconnecting five elements using ten fabrics.

FIG. 5 is a network diagram according to an exemplary embodiment for connecting 65 nodes using five elements and ten fabrics.

FIG. 6 is a block diagram according to an exemplary embodiment of a five-element network comprising two fabrics.

FIG. 7 is a block diagram according to an exemplary embodiment of a partial five-element network comprising an X fabric.

FIG. 8 is a block diagram according to an exemplary embodiment of a partial five-element network comprising a Y fabric.

FIG. 9 is a block diagram according to an exemplary embodiment of various endpoints connected to a node through X switches.

FIG. 10 is a block diagram according to an exemplary embodiment of various endpoints connected to a node through Y switches.

FIG. 11 is a block diagram according to an exemplary embodiment of various dual-ported endpoints connected to a node connected through a collection of X and Y switches.

FIG. 12 is a block diagram according to an exemplary embodiment of various endpoints and nodes connected as an X fabric.

FIG. 13 is a block diagram according to an exemplary embodiment of various endpoints and nodes connected as a Y fabric.

FIG. 14 is a block diagram according to an exemplary embodiment of various endpoints and nodes connected as a collection of an X and Y fabric.

FIG. 15 is a block diagram according to an exemplary embodiment of a nine-element network comprising two fabrics.

FIG. 16 is a block diagram according to an exemplary embodiment of a partial nine-element network comprising an X fabric.

FIG. 17 is a block diagram according to an exemplary embodiment of a partial nine-element network comprising a Y fabric.

FIG. 18 is a block diagram according to an exemplary embodiment of various endpoints connected to a node through X switches.

FIG. 19 is a block diagram according to an exemplary embodiment of various endpoints connected to a node through Y switches.

FIG. 20 is a block diagram according to an exemplary embodiment of various endpoints connected to a node through a collection of X and Y switches.

FIG. 21 is a block diagram according to an exemplary embodiment of various endpoints and nodes connected as an X fabric.

FIG. 22 is a block diagram according to an exemplary embodiment of various endpoints and nodes connected as a Y fabric.

FIG. 23 is a block diagram according to an exemplary embodiment of a 9-node network.

FIG. 24 is a block diagram according to an exemplary embodiment of various endpoints connected as a fabric.

FIG. 25 is a block diagram according to an exemplary embodiment of various endpoints connected as a fault-tolerant fabric.

FIG. 26 is a block diagram of an exemplary computer system.

### DETAILED DESCRIPTION

The drawing and description, in general, disclose a network and a method of configuring a network using a multi-fabric design process. This multi-fabric design process greatly facilitates the design of networks of various topologies and results in networks that are advantageous for a variety of reasons, as will be discussed below. For example, multi-fabric design enables the designer to find an optimal design in which each class of items appears in only the desired number of fabrics, in other words, without over-designing the network. Redundant paths may be provided in the network if desired by mapping, for example, two logical fabrics in the mathematical design into one physical fabric. Multi-fabric design may be used to design networks having symmetric or asymmetric fabrics, crossbar-only interconnects (single-hop networks), etc. An exemplary embodiment of the multi-fabric design process to be disclosed herein may be summarized in the following four steps.

Step 1. The starting point is a combinatorial design, generally a BIBD (Balanced Incomplete Block Design)—2-(ν, b, r, k, λ)—where small values of r are preferred. (νitems are grouped into b blocks of size k such that k<v and each item is in exactly r blocks and each set of 2 items, i.e. each pair, appears together in at least λ groups, as will be described below.)

Step 2. (optional) Partitioning the logical design of Step 1, if it is a partitionable BIBD. Graph-theoretic techniques are used when b=2; combinatorial techniques, when b>2.

Step 3. Each mathematical “item” from the previous steps is mapped into a “class.” A class may either be a singleton computer node or may have internal structure. If latter, the “class switches” may be shared between the different fabrics that the class connects into. Classes may also be assembled from disjoint subclasses, interconnectivity between which is deferred until Step 4. Recursive application of MFD is optional.

Step 4. The “blocks” from Steps 1 and 2—a.k.a. logical fabrics—are mapped into physical fabrics. Since k<v, each fabric is partial, in that not all the nodes of the topology are reachable through it. A fabric may be as simple as either a single link between a pair of classes or a singleton switch that connects all of the links that need to be connected. Generally, it is a network, possibly designed through recursive application of MFD.

If class sharing is used in Step 3, then the resulting topology will have fewer physical fabrics than logical ones. When there are only two physical fabrics but b>2, the special case of asymmetric fabrics occurs. Otherwise, when classes are implemented using singleton nodes in Step 3, and when singleton crossbar switches are used to realize physical fabrics in Step 4, the special case of crossbar-only interconnects (COIs) occurs. COI topologies uniquely extend the size of the largest system in which every pair of nodes is interconnected via a single crossbar switch.

It has thus been found that network designs with various advantages can be formed from mathematical concepts of balanced incomplete block designs (BIBDs). From these BIBDs a logical or virtual mapping can be derived for a network from which, in turn, a physical design is derived. In order to understand the present disclosure, however, it is useful to understand combinatorial block design and, in particular, balanced incomplete block design (BIBD). A block is a subset, s, of a set of elements, S, where block design considers choosing blocks with certain properties. A block design is called incomplete if at least one block does not contain the entire set of elements. A block design is balanced if each block has the same number of elements and each pair of elements occurs in a block the same number of times. For the purposes of the present approach, BIBD theory is used to design networks that have predetermined characteristics or properties.

With a BIBD, a pair (V, B) exists where V is a set of ν elements and B is a collection of b blocks that are subsets of k elements of V such that each element of V is contained in exactly r blocks and any two-subsets of V is contained in exactly λ blocks. The variables ν, b, r, k, and λ are parameters of a BIBD family also referred to as 2-(ν, b, r, k, λ) block design. In such a design, b groups are needed to connect ν elements arranged in groups of k, such that each pair of elements appears in exactly λ groups. Two conditions are established for the existence of a BIBD: (i) r(k−1)=λ(ν−1), and (ii) vr=bk. A consequence of these conditions is that three parameters, ν, k, and A, determine the remaining two parameters, r and b, from equations i and ii as follows:

$$\begin{matrix}r = \frac{λ ( v - 1 )}{k - 1} , and & ( 1 ) \\ b = \frac{v r}{k} . & ( 2 )\end{matrix}$$

With regard to equation 1, consider that an element, x, occurs in r blocks. Further consider that in each of those blocks, x is paired with k−1 other elements. Thus, x occurs in r(k−1) pairs of co-occurring elements. Further note that x must be paired with all other v−1 elements exactly λ times (i.e., λ(ν−1)) and equation 1 is therefore proven. It is straightforward to see that each block, b, contains k elements for a total of bk elements. Also, each element occurs in r blocks and since there are ν elements the total is vr, thus we have equation 2.

Accordingly, a BIBD (ν, b, r, k, λ) design can also be referred to as a (ν, k, λ) design. The notation 2-(ν, k, λ)=b is also used, since BIBDs are t-designs of the form t-(ν, k, λ) with t=2. Note that when λ=1 (i.e., 2-(ν, k, 1)), the notation S(2, k, ν) is also used denoting that these are Steiner systems (named after nineteenth century geometer Jakob Steiner). With regard to Steiner systems, given three integers, t, k, ν, such that 2≦t<k<ν, a Steiner system S(t, k, ν) is a set V of ν elements together with a family, B, of subsets of k elements of V (i.e., blocks) with the property that every subset of t elements of S is contained in exactly one block. Recall that in BIBD, t=2. These systems therefore determine the number of groups that are needed to connect ν elements, arranged in groups of k, such that a pair (i.e., “2-”) appears in exactly λ groups, where in a Steiner system λ=1 group.

Moreover, from Fisher's inequality, b≧ν. Designs with b=ν and r=k are called symmetric designs where every block contains k elements and every element occurs in r blocks. Also, every pair of elements occurs in λ blocks, and every pair of blocks intersects in λ elements.

Whereas BIBD designs can be quite complicated they can be represented in a two-dimensional, k×b array in which each column contains the elements forming a block. For example, consider the 2-(9, 3, 1)=12 design:

$$Elements \{ {\overbrace{\underline{\overline{\begin{matrix}0 & 0 & 0 & 0 & 1 & 1 & 1 & 2 & 2 & 2 & 3 & 6 \\ 1 & 3 & 4 & 5 & 3 & 4 & 5 & 3 & 4 & 5 & 4 & 7 \\ 2 & 6 & 8 & 7 & 8 & 7 & 6 & 7 & 6 & 8 & 5 & 8\end{matrix}}}} .}^{Blocks}$$

Here, for example, the first column represents the block containing elements e₀, e₁, and e₂ and the twelfth column represents a block having elements e₆, e₇, and e₈. In a larger design, letters can be used to represent blocks with more than 10 elements. The sequence 0, 1, . . . , 9, a, b, . . . , z can represent designs with up to 36 elements (i.e., 10 numerically represented elements and 26 alphabetically represented elements). Thus, the following 2-(16, 4, 1)=20 design can be represented as follows:

$$Elements \{ {\overbrace{\underline{\overline{\begin{matrix}0 & 0 & 0 & 0 & 0 & 1 & 1 & 1 & 1 & 2 & 2 & 2 & 2 & 3 & 3 & 3 & 3 & 4 & 5 & 6 \\ 1 & 4 & 7 & a & d & 4 & 5 & 6 & 9 & 4 & 5 & 6 & 8 & 4 & 5 & 6 & 7 & 8 & 9 & 7 \\ 2 & 5 & 8 & b & e & 7 & b & 8 & c & c & 7 & 9 & a & 9 & 8 & a & b & b & a & c \\ 3 & 6 & 9 & c & f & a & d & e & f & e & f & b & d & d & c & f & e & f & e & d\end{matrix}}}} .}^{Blocks}$$

With a design in hand, a BIBD can be further described by an incidence matrix A which has the blocks as its columns and elements (e.g., nodes) as the rows. Thus, an entry, a_{i,j} of the incidence matrix A is equal to one if the ith element resides in the jth block, otherwise it is equal to zero. For example, for a symmetric design with N elements, the incidence matrix is an N×N matrix.

$$\begin{matrix}Accordingly , the 2 \text{-} ( 9 , 3 , 1 ) = 12 design \\ Elements \{ {\overbrace{\underline{\overline{\begin{matrix}0 & 0 & 0 & 0 & 1 & 1 & 1 & 2 & 2 & 2 & 3 & 6 \\ 1 & 3 & 4 & 5 & 3 & 4 & 5 & 3 & 4 & 5 & 4 & 7 \\ 2 & 6 & 8 & 7 & 8 & 7 & 6 & 7 & 6 & 8 & 5 & 8\end{matrix}}}}}^{Blocks}\end{matrix}$$

described above is represented by the following incidence matrix:

$${A}_{2 - ( 9 , 3 , 1 )} = {\overbrace{[ \begin{matrix}1 & 1 & 1 & 1 & 0 & 0 & 0 & 0 & 0 & 0 & 0 & 0 \\ 1 & 0 & 0 & 0 & 1 & 1 & 1 & 0 & 0 & 0 & 0 & 0 \\ 1 & 0 & 0 & 0 & 0 & 0 & 0 & 1 & 1 & 1 & 0 & 0 \\ 0 & 1 & 0 & 0 & 1 & 0 & 0 & 1 & 0 & 0 & 1 & 0 \\ 0 & 0 & 1 & 0 & 0 & 1 & 0 & 0 & 1 & 0 & 1 & 0 \\ 0 & 0 & 0 & 1 & 0 & 0 & 1 & 0 & 0 & 1 & 1 & 0 \\ 0 & 1 & 0 & 0 & 0 & 0 & 1 & 0 & 1 & 0 & 0 & 1 \\ 0 & 0 & 0 & 1 & 0 & 1 & 0 & 1 & 0 & 0 & 0 & 1 \\ 0 & 0 & 1 & 0 & 1 & 0 & 0 & 0 & 0 & 1 & 0 & 1\end{matrix} ] \}}}^{Blocks} \begin{matrix}Incidence of \\ Elements\end{matrix} .$$

From a BIBD, network designs can in turn be generated by identifying certain correspondences. For example, given the blocks of a BIBD 2-(ν, k, λ), the mapping between BIBD and network design is given by the following table.

TABLE 1
Mapping from Block Design to Network Design

| Block Design | Network Design |
|---|---|
| Elements | Nodes or classes of nodes |
| Blocks | Fabrics or interconnections |
| λ (i.e., the number of pair-wise | The number of fabrics that |
| occurrences of elements) | interconnect a pair of nodes or |
| | classes of nodes |
| r (i.e., total occurrence of an element) | Degree of a node or the |
| | out-degree of a class |
| k (i.e., block size) | Length of routing |

A solution to a BIBD provides a partition of the ν elements into subsets such that there are exactly λ subsets for each pair of the elements and the distance between any two elements is at most k−1 and, at best, ┌logₘk┐ where the operator ┌•┐ denotes rounding up to the nearest integer, and the radix, m, is a technology-dependent constant.

Thus, the two important parameters of a block design are k and r. The size k of each block determines the maximum length of routing, and the total number of occurrences, r, of each element determines the degree requirement for such element in the target network. Particularly, smaller k leads to a better bound on the length of routing and smaller r requires a smaller number of network interface ports at endpoints in the target network.

For λ=1 (i.e., a Steiner system), each block of size k is unique for all possible pairs of k elements that it contains. That implies that each possible pairing of elements in a block corresponds to a unique candidate edge for the target topology. Furthermore, since such an edge never occurs in any other block, the virtual rings corresponding to the blocks are mutually edge-disjoint. Thus, each block of size k can induce a complete graph of k elements. In graph theory, any graph with k elements can be embedded into a complete graph with k elements.

Using the foregoing principles, a class of interconnect networks and multiple incomplete fabric interconnect systems are disclosed that can be used to simultaneously scale the performance and the reliability of either multi-computer cluster systems, switched input/output systems or switched processor-memory systems, while using fewer components than a traditional approach. In doing so, each end node, such as a computer, network-attached I/O device, or processor, has more than two network interface ports. The multiple ports can be provided either through the use of computers with network interface cards (NICs), each having one or more ports, or through the use of multi-port I/O nodes, or through the use of switched processor-memory chipsets. Preferably, this approach takes advantage of the dual-ported and multi-ported NICs that are a key part of widely used networks including, for example, ServerNet networks designed by the Hewlett-Packard Corporation. Such an approach can also be implemented in networks including Ethernet, GigaNet, Fibre Channel, ATM (Asynchronous Transfer Mode), RDMA-enabled Ethernet, PCI Xpress, InfiniBand, multiwavelength optical networks or other switched networks that have either been developed or will be developed in the future. Switched processor-memory subsystems include, but are not limited to, Sun UE10K, SGI Origin, Intel Profusion Chipset, and Compaq Alpha EV7. Switched IO subsystems include, but are not limited to, ServerNet, PCI Xpress, Stargen, InfiniBand and Rapid I/O.

In regards to the present approach, consider that a fabric is a collection of routers, switches, forwarding nodes, and links that interconnect a set of nodes. In the present discussion reference will be made to routers, switches, forwarding nodes, and other types of switching or interconnection devices that provide a path for and relay data between end nodes, in that they forward data from a receiving port to a sending port; it should be noted, however, that where a specific device is mentioned, the broader applicability of the present disclosure is intended to be illustrated with such particular example.

Further consider that a node may have one or more NICs (network interface cards), each with two or more ports. Among other things, each port allows a node to be on a distinct fabric. In one embodiment, fabrics, ports, and routers have color restrictions. For example, ports and routers are either red or green (note that the coloring described here can also be described with reference to X and Y designations). In a coloring scenario, it is illegal to connect a red port or router to a green port or router; i.e., there is either a red fabric or a green fabric. Stated another way, each fabric connects either red ports using only red routers (i.e., a red fabric) or, alternatively, green ports using only green routers (i.e., a green fabric), but there is no interconnection between colors. The problems underlying network topology design are minimizing diameter, maximizing bisection width, minimizing the number of routers, avoiding excessive link contention and avoiding hot links, and these problems are assumed to be important here. In some embodiments, however, coloring constraints are eliminated.

Several issues unique to multi-fabric topologies will now be examined. More particularly, a determination of how large each fabric needs to be will be examined. As a fundamental matter, fabrics collectively provide at least one path between each pair of nodes. While this can be accomplished with a large number of fabrics, a number of fabrics larger than necessary can waste routers by making redundant connections between nodes, thereby increasing costs.

A determination of how many fabrics are needed is also important: This is an important yet difficult matter to determine. In one embodiment, the number of fabrics is bounded either above or below, or both above and below, to determine an approximation for the optimal solution. As before, this will ensure that each pair of nodes appears together in at least one fabric, given a specific fabric size.

It is evident that redundant connections are inevitable and indeed desirable in all but the simplest of cases. Should redundant connections be present, a pair of nodes will co-occur in more than one fabric. Further, within each fabric, distance between nodes may vary from pair to pair. Rather than have some pair of nodes be far apart in all fabrics—and have other pairs be close together in more than one fabric—the multiple fabrics may be so arranged that each additional fabric causes the shortest available distances between some formerly far nodes to become smaller, perhaps at the expense of the additional fabric's distance between already closely connected nodes.

It should be noted that the multi-fabric design problem discussed here is different from the problem of multiple ports in one fabric. For example, multiple fabrics according to the present approach are likely to provide better protection for nodes against faults and congestion. Moreover, the diameter of a multi-fabric network is generally smaller than that of its single-fabric counterpart. This not only reduces the number of outstanding packets necessary for keeping pipelines full but also lowers the impact of output-port contention on link utilization. In effect, the multiple fabrics create congestion-containment domains or routing domains.

With the understanding that multi-fabric designs provide advantages over traditional solutions, we now turn to implementations of multi-fabric designs. Although several embodiments will be described, it can be understood that the present disclosure is not limited to the described embodiments.

Consider the following problem: given n nodes where each node connects top different fabrics, what is (1) the minimum number of fabrics and (2) the minimum fabric cardinality (the number of nodes in a fabric) required to ensure full connectivity between all nodes? Furthermore, what is a minimal assignment of connections to fabrics?

While the present discussion applies to both colored and non-colored fabric implementations, those implementations that completely ignore color will be considered first. In doing so, it has been found that n nodes can be connected using k fabrics of cardinality m such that

$$⌈ \frac{( \begin{matrix}n \\ 2\end{matrix} )}{( \begin{matrix}m \\ 2\end{matrix} )} ⌉ \leq k \qquad ( Equation 3 )$$

where ┌•┐ represents rounding up to the next whole number and

$$( \begin{matrix}i \\ j\end{matrix} )$$

represents the binomial coefficient Cⁱⱼ such that

$${C}_{j}^{i} = \frac{i !}{j ! ( i - j ) !} {Δ}_{=} ( \begin{matrix}i \\ j\end{matrix} )$$

denotes the number of different sub-populations of size j that can be chosen from a set of size i (i.e., i choose j). The above inequality follows from the requirement that every pair of nodes must be connected by at least one fabric. Moreover, since each fabric generates at most

$$( \begin{matrix}m \\ 2\end{matrix} )$$

pairs, and full connectivity among the nodes requires at least

$$( \begin{matrix}n \\ 2\end{matrix} )$$

pairs, the resulting lower bound on the number of fabrics, k, follows.

In considering the lower bound on fabric size, the neighborhood relationships of a single node are examined to impose a constraint that a node has to connect to all of its peers through a finite (and preferably small) number of ports. Using concepts from graph theory, consider that a node forms a vertex on a graph and an edge is an unordered pair of distinct vertices. It has therefore been found that with n nodes, each having p ports that are connected using fabrics of vertex cardinality m (i.e., the number of vertices),

$$m \geq ⌈ ( \frac{n + p - 1}{p} ) ⌉ . \qquad ( Equation 4 )$$

Notably, because a node has only p ports, it cannot connect to more than p fabrics. Moreover, because each fabric offers connections to only m−1 other neighbors, m must be large enough to cover all neighbors. Therefore,

$$⌈ \frac{n - 1}{m - 1} ⌉ \leq p$$

such that

(n−1)≦p(m−1)

(n−1)≦pm−

which we manipulate into the form

$$m \geq ⌈ ( \frac{n + p - 1}{p} ) ⌉ .$$

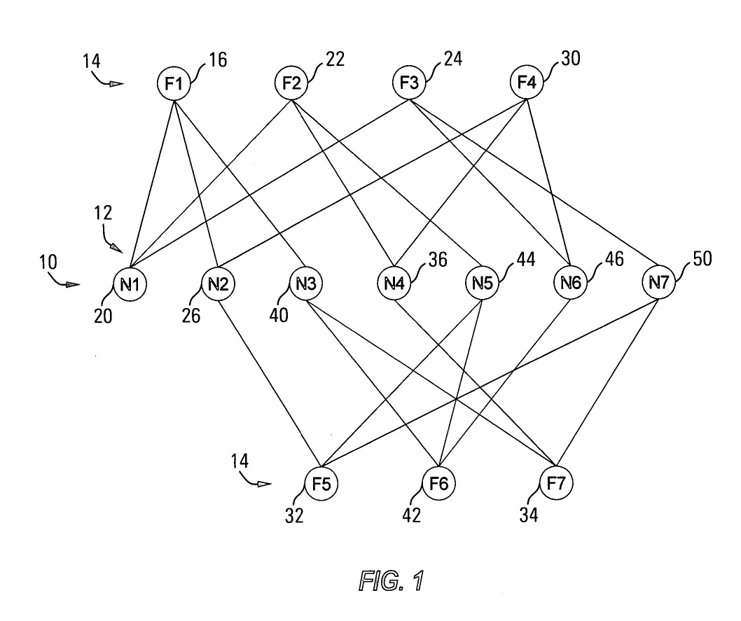

A straightforward example reinforces the above principles. As shown in FIG. 1, consider interconnecting seven nodes 10, corresponding to the previously described elements, each with three ports (e.g., 12). In fact, this problem corresponds to the BIBD of 2-(7, 3, 1)=7, that is, seven groups are needed to connect seven elements, arranged in groups of three, such that each pair of elements appears in exactly one group. Since each node must communicate to its 6 peers via only 3 ports, each fabric must have a size (i.e., vertex cardinality) of at least 3, according to Equation 4:

$$m \geq ⌈ ( \frac{7 + 3 - 1}{3} ) ⌉$$

$$m \geq 3.$$

Moreover, the minimum number of fabrics, according to Equation 3 is

$$⌈ \frac{( \begin{matrix}7 \\ 2\end{matrix} )}{( \begin{matrix}3 \\ 2\end{matrix} )} ⌉ \leq k$$

$$7 \leq k .$$

In this example, it is important to note that these lower bounds provide tight bounds. Indeed, the fact that both these lower bounds are tight, at least for certain cases, is illustrated by an assignment of nodes to fabrics as shown in Table 2.

TABLE 2
Assignment of Nodes

| Fabric | 1^{st} Node | 2^{nd} Node | 3^{rd} Node |
|---|---|---|---|
| 1 | Node 1 | Node 2 | Node 3 |
| 2 | Node 1 | Node 4 | Node 5 |
| 3 | Node 1 | Node 6 | Node 7 |
| 4 | Node 2 | Node 4 | Node 6 |
| 5 | Node 2 | Node 5 | Node 7 |
| 6 | Node 3 | Node 5 | Node 6 |
| 7 | Node 3 | Node 4 | Node 7 |

This shows that seven fabrics 14 of size three are not merely the minimum requirement but are also sufficient in this case. The topology of these interconnection fabrics is further shown in FIG. 1.

It is found that the coloring of fabrics adds strong constraints to the fabric partitioning problem. In fact, multi-fabric design with nodes having only two ports, where each port has a different color, may be impractical in all but the most trivial cases. Consider that if each node has only two ports, one red and one green, then at least one fabric must connect all of the nodes. This result can be shown by contradiction as follows. For example, suppose to the contrary that a node n connects to a red fabric F_{R} and a green fabric F_{G} in such a fashion that neither F_{R} nor F_{G} connects all of the nodes together, that is,

F_{R}⊂N and

F_{G}⊂N and

where N is the set of all nodes. Thus, either

F_{R}∪F_{G}=N

or

F_{R}∪F_{G}

is strictly a proper subset of N.

Since the latter case would imply incomplete connectivity for N, only the former can be accepted. Therefore,

F_{R}∪F_{G}=N

Since node n belongs to both red and green fabrics, there must exist nodes

n_{R}∈F_{R}

and

n_{G}∈F_{G}

such that

n_{R}≠n_{G},

n_{R}∉F_{G}, and

n_{G}∉F_{R}.

In order to achieve complete connectivity between all pairs of nodes, it is therefore necessary to add a fabric, say F_{X}, that will connect n_{R} to n_{G} where F_{X} could be neither red nor green. Because it is impossible to connect n_{R} to n_{G} using colored fabrics as constrained above, a contradiction exists. The only available ports for connecting to F_{X}, however, are green on n_{R} and red on n_{G}. Because our supposition has been contradicted, the opposite must be true, that is, at least one fabric must connect all the nodes.

It is because of this result that multi-fabric design was not attempted in traditional systems with only two ports, such as ServerNet I. With the availability of multi-port equipment, such as dual-PCI Compaq Professional Workstation platforms that support two NICs, each with two ports, called the X and Y ports, multi-fabric designs became feasible and, indeed, desirable because of their advantages. In implementing multi-fabric designs, it has been found, for example, that ServerNet II offers a flexible coloring of ports so that even with only one ServerNet II NIC, a node can have two ports of the same color. Partitioned fabric designs are therefore practical even in systems having only one ServerNet II NIC per node, but not practical in systems with only one ServerNet I NIC per node.

The further advantage of ServerNet II's flexible coloring of NIC ports becomes apparent when the fabric-partitioning solution described in Table 2 is examined. If all ports were the same color, the solution described above would function properly because fabric coloring would not be an issue. For nodes with a pair of ServerNet I NICs, however, two of the four ports on each node would be X ports and the other two would be Y ports. ServerNet I NICs and routers set and check the path bit, identifying a path as either X or Y, in almost all packets (except for default ports on routers); and, in general, it is not possible to route packets between X and Y ports and/or routers. With regard to Table 2, rows of the table (or, fabrics) should be colored in such a way that no node appears in more than two fabrics of the same color.

Let us now consider a specific impossibility argument in the context of Table 2 and then a general theorem for partitions with an odd number of fabrics. Without loss of generality, suppose that a fabric, say Fabric One 16, is colored red. Since Node One 20 has only two red ports and it appears on a total of three fabrics (Fabric One 16, Fabric Two 22 and Fabric Three 24), it must be that at least one of the other two fabrics 22 and 24 on which it appears must be green. Again, without loss of generality, suppose that a second fabric, say Fabric Two 22, is colored green. Applying the same argument to Node Two 26, either Fabric Four 30 or Fabric Five 32 must be green. Suppose that Fabric Four 30 is green. Next, consider Fabric Seven 34. Since both the green ports on Node Four 36 are used up, this fabric 34 must be colored red. Doing so uses up both the red ports on Node Three 40. Hence, Fabric Six 42 must be colored green. Doing so uses up both the green ports at Node Five 44. Hence, Fabric Five 32 must be colored red. Now, we need to assign a color to Fabric Three 24 which connects Nodes One 20, Six 46, and Seven 50, but both green ports are used up on Node Six 46 as well as both red ports on Node Seven 50. It is therefore impossible to pick a color for Fabric 3 24.

In proceeding, we will further be constrained by the mathematical impossibility of coloring an odd number of fabrics with two colors—say, red and green—if each node has an equal number of red and green ports.

Having now considered lower bounds, it is important to consider also upper bounds. Although redundancy may be inevitable, redundancy can be quantified by fixing at the outset the number of nodes that will co-occur in all fabrics. Optimal solutions may not always be possible, but an interesting effect is that we can always come up with a feasible solution. Since the solutions so found yield closed-form expressions for both the size and the number of fabrics, those expressions serve as upper bounds on the respective quantities. The key observation here is that many nodes may connect to the same collection of fabrics, and these equivalent nodes can be handled together in an equivalence class. Equivalence classes can be thought of as nodes that always co-occur in fabrics. Equivalence classes are a natural algebraic abstraction for the multi-fabric design problem because connectedness, the primary relationship of interest here, is, algebraically speaking, an equivalence relation in that it is trivially reflexive, symmetric and transitive. A solution is constructed by increasing the number of equivalence classes.

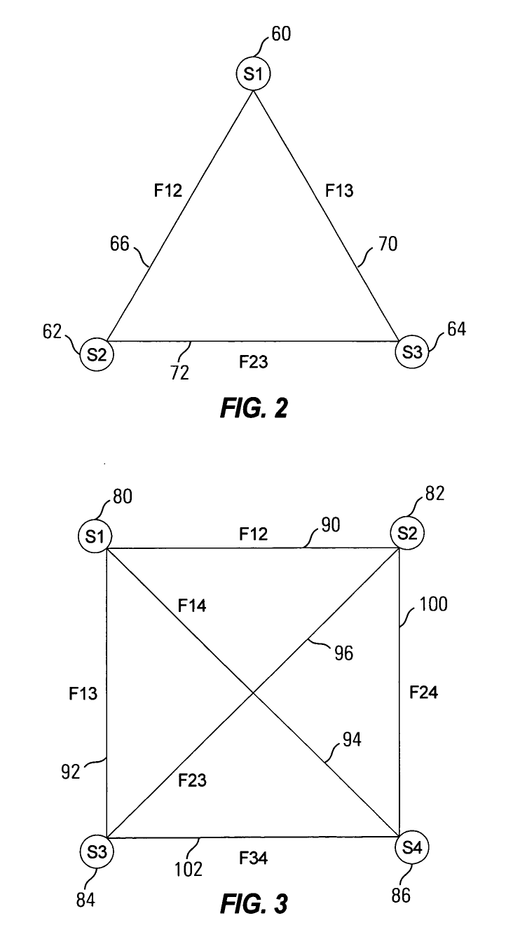

For illustrative purposes only, we first consider a restricted set of embodiments of the present teachings where each fabric interconnects exactly two equivalence classes and where each class is a simple grouping of unconnected singleton endpoints. While arbitrary, this restriction allows us to demonstrate the present teachings using graphical techniques as follows. In the graphs of FIGS. 2, 3, and 4, each vertex 60, 62 and 64 represents an equivalence class, and each edge 66, 70 and 72 represents the fabric that interconnects the two classes corresponding to its two vertices. For the degenerate and trivial cases of one or two classes (not shown graphically), a single fabric connects all of the nodes, and each node needs only one fabric connection. That stated, we turn to more useful designs.

In partitioning nodes into three equivalence classes, S₁ 60, S₂ 62, and S₃ 64, as shown in FIG. 2, each class connects to two fabrics and there are three total fabrics 66, 70 and 72. Fabric F₁₂ 66 connects all of the nodes in classes S₁ 60 and S₂ 62, Fabric F₁₃ 70 connects all of the nodes in classes S₁ 60 and S₃ 64, and fabric F₂₃ 72 connects all of the nodes in classes S₂ 62 and S₃ 64. With four equivalence classes 80, 82, 84 and 86, as shown in FIG. 3, each class (e.g., 80) connects to three fabrics (e.g., 90, 92 and 94) and there are

$$( \begin{matrix}4 \\ 2\end{matrix} ) = 6$$

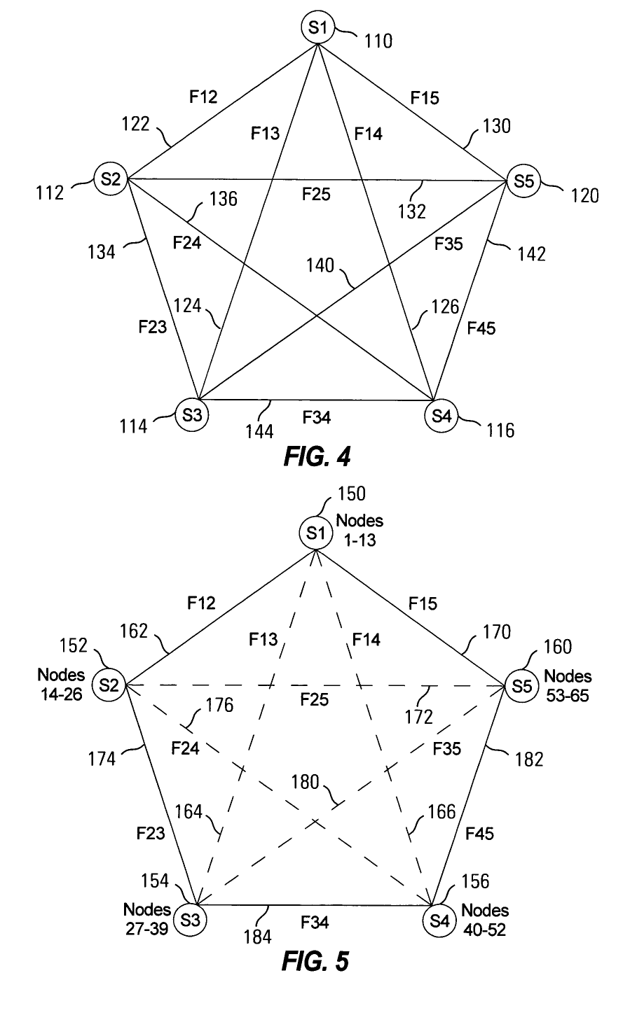

different fabrics 90, 92, 94, 96, 100, and 102 in all. With five equivalence classes 110, 112, 114, 116 and 120, as shown in FIG. 4, each class (e.g., 110) connects to four fabrics (e.g., 122, 124, 126 and 130) and there are

$$( \begin{matrix}5 \\ 2\end{matrix} ) = 10$$

total fabrics 122, 124, 126, 130, 132, 134, 136, 140, 142 and 144.

More particularly, the graph of FIG. 4 represents a 64-node cluster where each class (e.g., 110) has four connections (e.g., 122, 124, 126 and 130). In an embodiment this is achieved with nodes having two ServerNet NICs, each with an X port and a Y port. With these specifications, the network of FIG. 5 is built. In order to simplify the design, the nodes are partitioned into equivalence classes where each fabric is a pairing of equivalence classes. With five equivalence classes, S1-S5 150, 152, 154, 156 and 160 as shown in FIG. 5, each node (e.g., 150) connects to four fabrics (e.g., 162, 164, 166 and 170) and there are ten total fabrics 162, 164, 166, 170, 172, 174, 176, 180, 182 and 184. Rounding the number of nodes up to 65, we have 13 (i.e., 65/5=13) nodes per class with each fabric connecting 26 (i.e., 2×13=26) nodes. Note that if each fabric were a simple Steiner tree, 26 nodes would require 6 6-port routers such that the 64-node configuration can be done in 6*10=60 routers. The complete solution is therefore shown in FIG. 5. Coloring constraints are easily satisfied because the perimeter of the pentagon can be built with X fabrics 162, 170, 174, 182 and 184 (shown as solid lines) and the core can be built with Y fabrics 164, 166, 172, 176 and 180 (shown as dashed lines). Indeed, an important result is that it provides for fault-tolerant systems; the occurrence of a failure anywhere in the system will not render the rest of the system useless. Moreover, the present approach provides for redundant interconnection paths such that if a failure does occur, a redundant path is available.

Indeed, the above technique of “fabrics as class pairs” can be extended to more general network configurations with the understanding of equivalence classes. For interconnecting nodes with p ports, there are (p+1) equivalence classes. With n such nodes, the vertex cardinality of each fabric is given by

$$m = 2 ⌈ \frac{n}{p = 1} ⌉ . \qquad ( Equation 5 )$$

Notably, the concept of equivalence classes plays an important role in this solution as will be further explained. Bisection bandwidth (the minimum number of paths, when considering all possible partitions, which must cross if a design is partitioned into two equal halves) is observed to be good for the resulting network topologies, but it can be difficult to compute because the number of classes is usually odd. Using a tree for each fabric, the 64-node topology discussed above has a bisection bandwidth of greater than ten (10) links. Because of the high cost of the 60 routers, adoption of such a design can be difficult. The quality of solutions generated—as quantified by, say, bisection width and number of routers needed—depends upon the size of equivalence classes. The smaller the class size, the smaller is the number of connections that repeat in all fabrics. Because each node participates in p fabrics, the connections within a node's equivalence class are redundantly repeated (p−1) times. Thus, it can be seen that the larger the class size, the greater is the waste. When each fabric connects only two simple classes (which is not a requirement of the present teachings but rather an arbitrary restriction needed for illustrative purposes and only in these first few embodiments), given the lower bounds on fabric size discussed above, class size must be at least

$$Class size \geq ⌈ ( \frac{n + p - 1}{2 p} ) ⌉ . \qquad ( Equation 6 )$$

For the 64-node topology shown in FIG. 5, the bounds of Equations 3 and 4 suggest a minimum fabric cardinality of 17, and a minimum fabric count of 15. At 26, the network of FIG. 5 has sufficient fabric cardinality, but, subjectively, a larger than necessary number of fabrics may be in use. For fabric cardinality 26, the lower bound on the number of fabrics is 7, according to Equation 3. At 10, the number of fabrics in the network of FIG. 5 is significantly above that minimum value. Whereas the illustrative discussion above confirms the feasibility of designing networks with multiple fabrics, it also shows that the illustrative “fabrics as class pairs” approach does not always yield either optimal or near-optimal fabric count for a given fabric cardinality. The discussion of this first set of embodiments is nevertheless useful because it does yield tight lower bounds on fabric size and fabric cardinality, as well as provides upper bounds through the construction of multi-fabric designs in which each fabric interconnects a pair of equivalence classes.

Furthermore, certain designs produced using the “fabrics as class pairs” approach are guaranteed to satisfy the hard-to-satisfy color constraint of multi-fabric partitioning described earlier. The bounding results of the “fabrics as class pairs” design are therefore summarized here for the optimal fabric size

| Fabric Parameter | Lower Bound | Upper Bound |
|---|---|---|
| Optimal Fabric Size (m_{O}) | $⌈ \frac{n + p - 1}{p} ⌉$ | $2 ⌈ \frac{n}{p + 1} ⌉$ |

and the optimal number of fabrics.

| Fabric Parameter | Lower Bound | Upper Bound |
|---|---|---|
| Optimal Number of Fabrics (k_{O}) | $⌈ \frac{( \begin{matrix}n \\ 2\end{matrix} )}{( \begin{matrix}m \\ 2\end{matrix} )} ⌉$ | $( \begin{matrix}p + 1 \\ 2\end{matrix} )$ |

The discussion above has demonstrated that whereas the lower bounds are tight, the upper bounds are not. The discussion that follows describes embodiments that, instead of starting with arbitrary groupings, translate BIBDs into network designs in order to equal or more closely approximate the lower bounds on fabric count and cardinality.

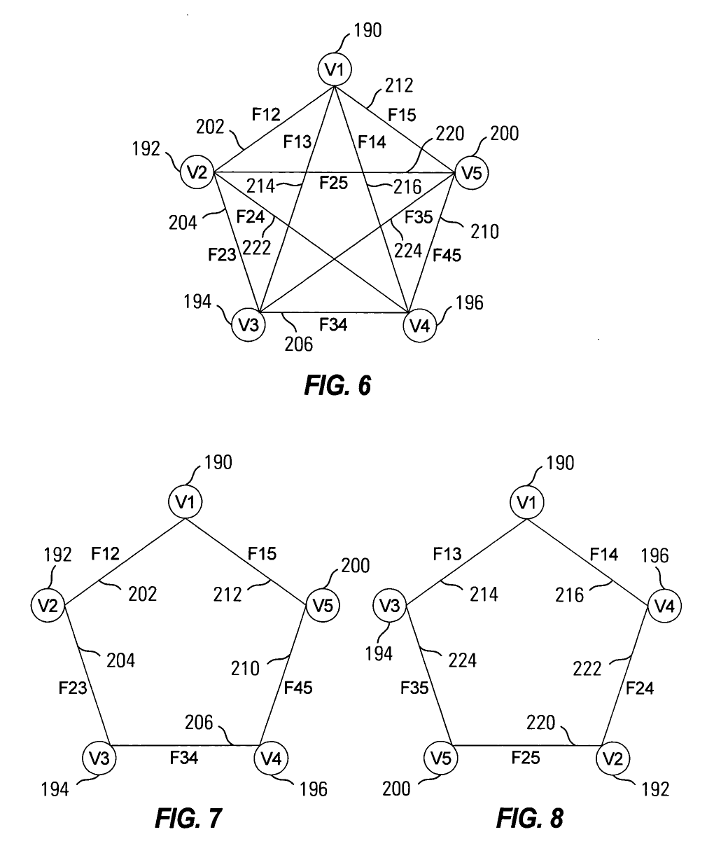

In a first example a 2-(5, 2, 1)=10 BIBD will be described. Recall that this BIBD was discussed with reference to FIG. 4 as a BIBD where 10 groups are needed to connect five elements 110, 112, 114, 116 and 120, arranged in groups of two, such that each pair of elements appear in one group. FIG. 4 is redrawn as FIG. 6 for clarity in the discussion to follow. This BIBD therefore corresponds to a design of 5 elements 190, 192, 194, 196 and 200, with 2 elements per group, resulting in 10 groups. Where the 5 elements are nodes V1-V5 190, 192, 194, 196 and 200, the 10 groups are therefore the node-to-node connections F12 202 (otherwise identified as {V1, V2} in the fabric equation below), F23 204, F34 206, F45 210, F15 212, F13 214, F14 216, F25 220, F24 222, and F35 224:

$$F \to \{ \begin{matrix}\{ V1 , V2 \} , \\ \{ V2 , V4 \} ,\end{matrix} \begin{matrix}\{ V1 , V3 \} , \\ \{ V2 , V5 \} ,\end{matrix} \begin{matrix}\{ V1 , V4 \} , \\ \{ V3 , V4 \} ,\end{matrix} \begin{matrix}\{ V1 , V5 \} , \\ \{ V3 , V5 \} ,\end{matrix} \begin{matrix}\{ V2 , V3 \} , \\ \{ V4 , V5 \}\end{matrix} \}$$

As shown in FIG. 6, this collection of groups 204-224 can therefore be considered a fabric, F. Notably, the logical groups 204-224 comprising fabric F can be partitioned across two partial fabrics to be called X fabric, F_{X}, consisting of node-to-node connections F12 202, F23 204, F34 206, F45 210 and F15 212, and Y fabric, F_{Y}, consisting of node-to-node connections F13 214, F14 216, F25 220, F24 222, and F35 224. In particular we note the following partitioning of the fabric, F:

F_{X} [symbol] {{V1, V2}, {V2, V3}, {V3, V4}, {V4, V5}, {V1, V5}}

F_{Y} [symbol] {{V1, V3}, {V3, V5}, {V2, V5}, {V2, V4}, {V1, V4}}

Thus, the union of F_{X} and F_{Y} provides for the fabric F=F_{X}∪F_{Y}.

The outer ring of groups serially connects nodes V1 190 to V2 192 to V3 194 to V4 196 to V5 200 and back to V1 190 (as shown in FIG. 6). The outer ring is, in one instance, an X fabric, F_{X}, as shown in FIG. 7. An inner star of groups serially connects nodes V1 190 to V3 194 to V5 200 to V2 192 to V4 196 and back to V1 190. This star pattern can be reorganized in the form of a ring called a Y fabric, F_{Y}, with identical connections as shown in FIG. 8. Accordingly, the collection of groups, F, as shown in FIG. 6 can be redrawn as the union of two rings of groups, F_{X} and F_{Y} (i.e., F=F_{X}∪F_{Y}) as shown in FIGS. 7 and 8, respectively.

We now turn to what has been referenced above as classes or equivalence classes of nodes. An equivalence class is a group of similarly connected nodes or endpoints. For clarity of discussion, we will call these “endpoints” while using the term “node” for the various nodes V1-V5. In the field to which it pertains, either term, “endpoint” or “node,” or even other terms (e.g., “port”), may be used to describe the same items. Accordingly, no definitions are made here. Rather, the usage of specific terms is meant to lend toward understanding the present disclosure.

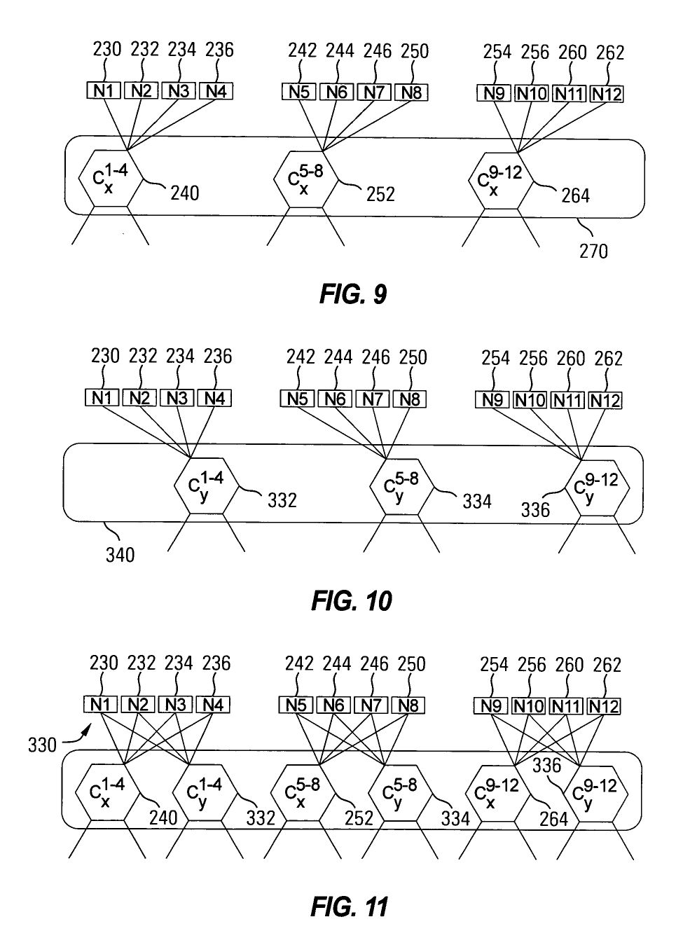

Unlike the simple equivalence classes of FIG. 5, which consisted only of unconnected singleton endpoints, the equivalence classes of FIGS. 6 to 8 are internally connected as shown in FIGS. 9 to 11. There are two principal advantages of such internal connectivity within a class. First, the number of physical network interface ports at endpoints does not need to precisely match the rank (in the BIBD) of the class containing that endpoint. Second, the switches and routers used for internal connectivity within a class can be shared between certain groups of classes. In particular, it is possible and, in accordance with the principles of the current teachings, advantageous that class routers be shared between those groups that have a non-empty intersection and, after partitioning, still map into the same fabric, as described below.

As shown in FIG. 9, four endpoints, N₁ 230, N₂ 232, N₃ 234, and N₄ 236, are connected to a six-port switch 240 configured as a 4-in-2-out switch C_{X}¹⁻⁴ (here X denotes the “X” fabric). Similarly, four endpoints, N₅ 242, N₆ 244, N₇ 246, and N₈ 250, are connected to a 4-in-2-out switch C_{X}⁵⁻⁸ 252; and four endpoints, N₉ 254, N₁₀ 256, N₁₁ 260, and N₁₂ 262, are connected to a 4-in-2-out switch C_{X}⁹⁻¹² 264. Here, the collection of 12 nodes 230-236, 242-250 and 254-262 can be considered as an equivalence class of nodes (endpoints) connected to a node (for example, node V1 190 of FIG. 7). The following notation, therefore describes the above connections into the X fabric for node V1 190:

V1_{X} [symbol] {C_{X}¹⁻⁴(N₁, N₂, N₃, N₄), C_{X}⁵⁻⁸(N₅, N₆, N₇, N₈), C_{X}⁹⁻¹²(N₉, N₁₀, N₁₁, N₁₂)}

Each collection of four nodes mentioned above is considered a sub-class of nodes. Of course, in other embodiments what is a sub-class here can be considered a class in itself.

As noted before, the switches C_{X}¹⁻⁴ 240, C_{X}⁵⁻⁸ 252, and C_{X}⁹⁻¹² 264, are associated with the X fabric, F_{X}, shown in FIG. 7. Accordingly, where such switches are associated with node V1 190, for example, each switch then connects to both nodes V2 192 and V5 200 according to the diagram. This same type of configuration can be used for each node of the fabric Fₓ such that:

V2_{X} [symbol] {C_{X}¹³⁻¹⁶(N₁₃, N₁₄, N₁₅, N₁₆), C_{X}¹⁷⁻²⁰(N₁₇, N₁₈, N₁₉, N₂₀), C_{X}²¹⁻²⁴(N₂₁, N₂₂, N₂₃, N₂₄)}

V3_{X} [symbol] {C_{X}²⁵⁻²⁸(N₂₅, N₂₆, N₂₇, N₂₈), C_{X}²⁹⁻³²(N₂₉, N₃₀, N₃₁, N₃₂), C_{X}³³⁻³⁶(N₃₃, N₃₄, N₃₅, N₃₆)}

V4_{X} [symbol] {C_{X}³⁷⁻⁴⁰(N₃₇, N₃₈, N₃₉, N₄₀), C_{X}⁴¹⁻⁴⁴(N₄₁, N₄₂, N₄₃, N₄₄), C_{X}⁴⁵⁻⁴⁸(N₄₅, N₄₆, N₄₇, N₄₈)}

V5_{X} [symbol] {C_{X}⁴⁹⁻⁵²(N₄₉, N₅₀, N₅₁, N₅₂), C_{X}⁵³⁻⁵⁶(N₅₃, N₅₄, N₅₅, N₅₆), C_{X}⁵⁷⁻⁶⁰(N₅₇, N₅₈, N₅₉, N₆₀)}.

Thus, switches C_{X}¹⁻⁴ 240, C_{X}⁵⁻⁸ 252, and C_{X}⁹⁻¹² 264 are associated with the node V1_{X} 270, switches C_{X}¹³⁻¹⁶ 272, C_{X}¹⁷⁻²⁰ 274, and C_{X}²¹⁻²⁴ 276 are associated with the node V2_{X} 280, switches C_{X}²⁵⁻²⁸ 282, C_{X}²⁹⁻³² 284, and C_{X}³³⁻³⁶ 286 are associated with the node V3_{X} 290, switches C_{X}³⁷⁻⁴⁰ 292, C_{X}⁴¹⁻⁴⁴ 294, and C_{X}⁴⁵⁻⁴⁸ 296 are associated with the node V4_{X} 300, and switches C_{X}⁴⁹⁻⁵² 302, C_{X}³⁻⁵⁶ 304, and C_{X}⁵⁷⁻⁶⁰ 306 are associated with the node V5_{X} 310.

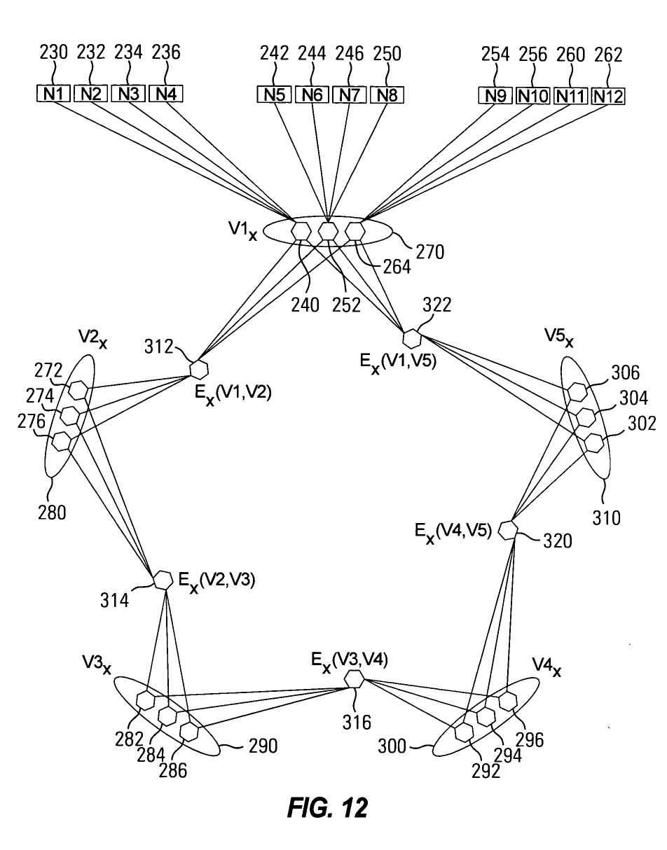

A full implementation of the fabric F_{X} can then be configured as shown in FIG. 12. For clarity of presentation, only the switches are shown while omitting the endpoints connected to the switches. In implementing the fabric F_{X} of FIG. 12, inter-node connectivity is provided by 6-port routers Ex(v1,v2) 312, Ex(v2,v3) 314, Ex(v3,v4) 316, Ex(v4,v5) 320 and Ex(v1,v5) 322 in accordance with the ring connection:

F_{X} [symbol] {E_{X}(V1_{X}, V2_{X}), E_{X}(V2_{X}, V3_{X}), E_{X}(V3_{X}, V4_{X}), E_{X}(V4_{X}, V5_{X}), E_{X}(V1_{X}, V5_{X})}.

Note that the subscript denotes the fabric and the argument denotes the node-to-node connections. These 6-port routers 312-322 then allow for 3-port connectivity from node to node (e.g., node V1 270 to node V2 280, etc.).

In the same manner that the X fabric, F_{X}, is configured, the Y fabric can similarly be configured. With reference to FIG. 10, the similarities to FIG. 9 are evident. In particular, note that the endpoints 230-236, 242-250 and 254-262 of FIG. 10 are the same as those of FIG. 9. That is, each endpoint (e.g., 230) has two ports (e.g., 330), one for communication on the X fabric F_{X} and one for communication on the Y fabric, F_{Y}.

Switches C_{Y}¹⁻⁴ 332, C_{Y}⁵⁻⁸ 334, and C_{Y}⁹⁻¹² 336 of FIG. 10, however, are distinct from those of FIG. 9 in that they are associated with the Y fabric, F_{Y}. The following notation, therefore describes the above connections for the Y fabric connections of node V1:

V1_{Y} [symbol] {C_{Y}¹⁻⁴ (N₁, N₂, N₃, N₄), C_{Y}⁵⁻⁸(N₅, N₆, N₇, N₈), C_{Y}⁹⁻¹²(N₉, N₁₀, N₁₁, N₁₂)}

This same type of configuration can be used for each of nodes of the fabric F_{Y} such that:

V2_{Y} [symbol] {C_{Y}¹³⁻¹⁶(N₁₃, N₁₄, N₁₅, N₁₆), C_{Y}¹⁷⁻²⁰(N₁₇, N₁₈, N₁₉, N₂₀), C_{Y}²¹⁻²⁴(N₂₁, N₂₂, N₂₃, N₂₄)}

V3_{Y} [symbol] {C_{Y}²⁵⁻²⁸(N₂₅, N₂₆, N₂₇, N₂₈), C_{Y}²⁹⁻³²(N₂₉, N_{30 9}, N₃₁, N₃₂), C_{Y}³³⁻³⁶(N₃₃, N₃₄, N₃₅, N₃₆)}

V4_{Y}{C_{Y}³⁷⁻⁴⁰(N₃₇, N₃₈, N₃₉, N₄₀), C_{Y}⁴¹⁻⁴⁴(N₄₁, N₄₂, N₄₃, N₄₄), C_{Y}⁴⁵⁻⁴⁸(N₄₅, N₄₆, N₄₇, N₄₈)}

V5_{Y} [symbol] {C_{Y}⁴⁹⁻⁵²(N₄₉, N₅₀, N₅₁, N₅₂), C_{Y}⁵³⁻⁵⁶(N₅₃, N₅₄, N₅₅, N₅₆), C_{Y}⁵⁷⁻⁶⁰(N₅₇, N₅₈, N₅₉, N₆₀)}.

Thus, switches C_{Y}¹⁻⁴ 332, C_{Y}⁵⁻⁸ 334, and C_{Y}⁹⁻¹² 336 are associated with the node V1_{Y} 340, switches C_{Y}¹³⁻¹⁶ 342, C_{Y}¹⁷⁻²⁰ 344, and C_{Y}²¹⁻²⁴ 346 are associated with the node V1_{Y} 370, switches C_{Y}²⁵⁻²⁸ 352, C_{Y}²⁹⁻³² 354, and C_{Y}³³⁻³⁶ 356 are associated with the node V3_{Y} 350, switches C_{Y}³⁷⁻⁴⁰ 362, C_{Y}⁴¹⁻⁴⁴ 364, and C_{Y}⁴⁵⁻⁴⁸ 366 are associated with the node V4_{Y} 380, and switches C_{Y}⁴⁹⁻⁵² 372, C_{Y}⁵³⁻⁵⁶ 374, and C_{Y}⁵⁷⁻⁶⁰ 376 are associated with the node V5_{Y} 360.

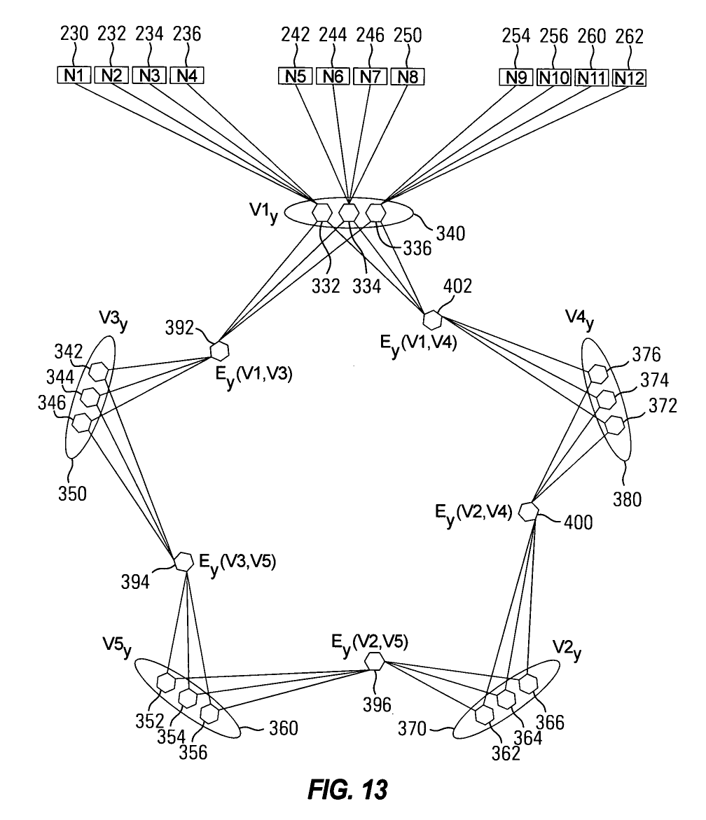

With reference now to FIG. 13, the similarities to FIG. 12 are again evident. In FIG. 13, however, the node-to-node connections are in accordance with the Y fabric, F_{Y}, configuration. Here, inter-node connectivity is provided by 6-port routers Ey(v1,v3) 392, Ey(v3,v5) 394, Ey(v2,v5) 396, Ey(v2,v4) 400 and Ey(v1,v4) 402 with different node-to-node connections:

F_{Y} [symbol] {E_{Y}(V1_{Y}, V3_{Y}), E_{Y}(V3_{Y}, V5_{Y}), E_{Y}(V2_{Y}, V5_{Y}), E_{Y}(V2_{Y}, V4_{Y}), E_{Y}(V1_{Y}, V4_{Y})}.

Note that here, the node-to-node connections correspond to the star configuration of FIG. 6 and the reorganized ring configuration of FIG. 8.

Thus, FIGS. 12 and 13 depict the fabrics F_{X} and F_{Y} respectively. As previously discussed, the union of the two fabrics composes the complete fabric, F=F_{X}∪F_{Y} such that

V1=V1_{X}520 V1_{Y}

V1 [symbol] {C_{X}¹⁻⁴(N₁, N₂, N₃, N₄), C_{X}⁵⁻⁸(N₅, N₆, N₇, N₈), C_{X}⁹⁻¹²(N₉, N₁₀, N₁₁, N₁₂)}∪{C_{Y}¹⁻⁴(N₁, N₂, N₃, N₄), C_{Y}⁵⁻⁸(N₅, N₆, N₇, N₈) C_{Y}⁹⁻¹²(N₉, N₁₀, N₁₁, N₁₂)}

V2=V2_{X}∪V2_{Y}

V2 [symbol] {C_{Y}¹³⁻¹⁶(N₁₃, N₁₄, N₁₅, N₁₆), C_{X}¹⁷⁻²⁰(N₁₇, N₁₈, N₁₉, N₂₀), C_{Y}²¹⁻²⁴(N₉, N₂₂, N₂₃, N₂₄)}∪{C_{Y}¹³⁻¹⁶(N₁₃, N₁₄, N₁₅, N₁₆), C_{Y}¹⁷⁻²⁰(N₁₇, N₁₈, N₁₉, N₂₀), C_{Y}²¹⁻²⁴(N₂₁, N₂₂, N₂₃, N₂₄)}

V3=V3_{X}∪V3_{Y}

V3 [symbol] {C_{X}²⁵⁻²⁸(N₂₅, N₂₆, N₂₇, N₂₈), C_{X}²⁹⁻³²(N₂₉, N₃₀, N₃₁, N₃₂), C_{X}³³⁻³⁶(N₃₃, N₃₄, N₃₅, N₃₆)}∪{C_{Y}²⁵⁻²⁸(N₂₅, N₂₆, N₂₇, N₂₈), C_{Y}²⁹⁻³²(N₂₉, N₃₀, N₃₁, N₃₂), C_{Y}³³⁻³⁶(N₃₃, N₃₄, N₃₅, N₃₆)}

V4=V4_{X}∪V4_{Y}

V4 [symbol] {C_{X}³⁷⁻⁴⁰(N₃₇, N₃₈, N₃₉, N₄₀), C_{X}⁴¹⁻⁴⁴(N₄₁, N₄₂, N₄₃, N₄₄), C_{X}⁴⁵⁻⁴⁸(N₄₅, N₄₆, N₄₇, N₄₈)}∪{C_{Y}³⁷⁻⁴⁰ (N₃₇, N₃₈, N₃₉, N₄₀)C_{Y}⁴¹⁻⁴⁴ (N₄₁, N₄₂₃ N₄₃, N₄₄), C_{Y}⁴⁵⁻⁴⁸(N₄₅, N₄₆, N₄₇, N₄₈)}

V5=V5_{X}∪V2_{Y}

V5 [symbol] {C_{X}⁴⁹⁻⁵²(N₄₉, N₅₀, N₅₁, N₅₂), C_{X}⁵³⁻⁵⁶(N₅₃, N₅₄, N₅₅, N₅₆), C_{X}⁵⁷⁻⁶⁰(N₅₇, N₅₈, N₅₉, N₆₀)}∪{C_{Y}⁴⁹⁻⁵²(N₄₉, N₅₀, N₅₁, N₅₂), C_{X}⁵³⁻⁵⁶(N₅₃, N₅₄, N₅₅, N₅₆), C_{Y}⁵⁷⁻⁶⁰(N₅₇, N₅₈, N₅₉, N₆₀)}.

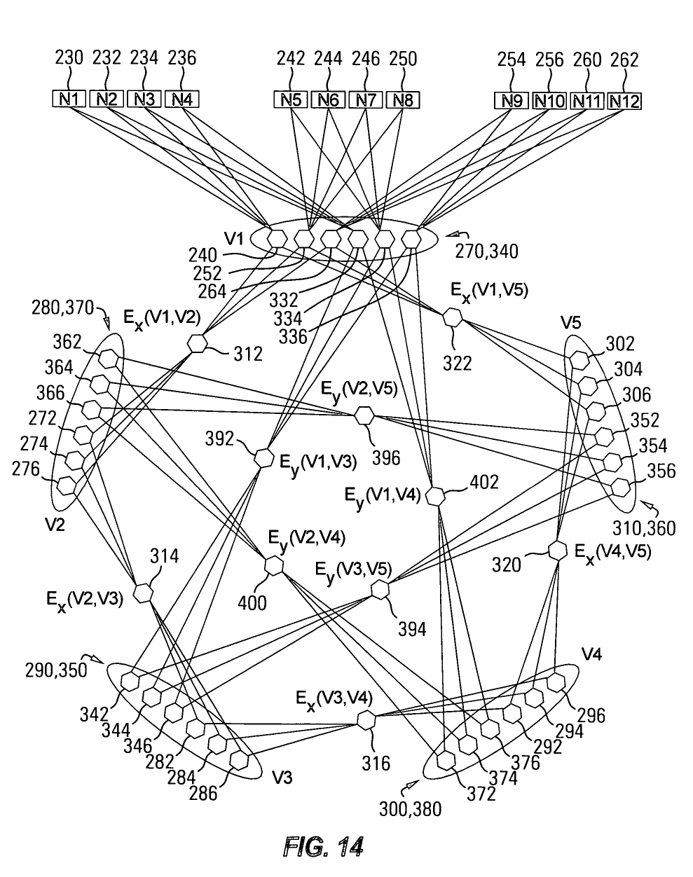

To demonstrate how this may be done, FIG. 14 shows the union of the configurations discussed for FIGS. 12 and 13. As shown in FIG. 14, note that the endpoints 230-236, 242-250 and 254-262 are again the same. Here, however, the endpoints are shown with the two port connections, one for the X fabric and one for the Y fabric. Moreover, as shown in FIG. 14, 4-in-2-out switches, C_{X}¹⁻⁴ 240, C_{X}⁵⁻⁸ 252 and C_{X}⁹⁻¹² 264 associated with the X fabric are shown along with 4-in-2-out switches, C_{Y}¹⁻⁴ 332, C_{Y}⁵⁻⁸ 334 and C_{Y}⁹⁻¹² 336 associated with the Y fabric. Thus we have

F=F_{X}520 F_{Y}

F [symbol] {E_{X}(V1_{X}, V2_{X}), E_{X}(V2_{X}, V3ₓ), E_{X}(V3_{X}, V4_{X}), E_{X}(V2_{X}, V5_{X}), E_{X}(V1_{X}, V5_{X})} ∪{E_{Y}(V1_{Y}, V3_{Y}), E_{Y}(V3_{Y}, V5_{Y}), E_{Y}(V2_{Y}, V5_{Y}), E_{Y}(V2_{Y}, V4_{Y}), E_{Y}(V1_{Y}, V4_{Y})}.

Thus, the complete fabric F is configured as shown in FIG. 14. Notably, the fabric F allows for complete inter-node connectivity, that is, every node can directly communicate with every other node. Moreover, the fabric F provides for intra-class connectivity, that is, every endpoint within a class can communicate with another endpoint of the same class. More particularly, intra-sub-class connectivity is provided by the 4-in-2-out switches (e.g., 240) and inter-sub-class connectivity within the same class is provided by the 6-port routers (e.g., 312). Of course, inter-class connectivity is provided by inter-node connectivity. We therefore achieve the desirable result that every endpoint is communicatively coupled to every other endpoint.

In considering FIG. 14, the concept of class-router sharing is clearly evident. For instance, the 4-in-2-out switches (e.g., 240) that provide intra-class connectivity are repeated not on a per-group basis but rather on a per-fabric basis. Thus, even though each endpoint connects to 4 total groups per the mathematical design of FIG. 6, it needs only two network interface ports per the physical network topology of FIG. 14, one for the X fabric and one for the Y fabric. This contrasts with the design of FIG. 5, where each endpoint needed four network interface ports in order to precisely match the rank of its equivalence class. In other embodiments, whenever there is a design challenge brought about by a mismatch between the rank of a BIBD and the number of physical ports that an endpoint is constrained to use, the principle of class-router sharing may be used in accordance with the principles of the present teachings in order to overcome that design challenge. For example, with respect to FIG. 14, the class router C_{X}¹⁻⁴ 240 is shared between the groups {V1, V2} and {V1, V5} in the X fabric and the class router C_{Y}¹⁻⁴ 332, between the groups {V1, V3} and {V1, V4} in the Y fabric. The embodiments that follow take advantage of class router sharing as described above.

For connecting 64 nodes using 6-port crossbar switches, the topology of FIG. 14 uses only 40 switches and satisfies some highly desirable properties. For example, such a design exhibits low latency. Here, there are 3 or fewer switches on the best path between any pair of endpoints. A prior art approach, such as MINs, Clos networks and k-ary n-cubes, would have put 5 switches on the best path for certain node pairs. The present approach also exhibits desirable redundant connectivity. Here, there are two completely independent paths between any pair of nodes, one in the X fabric and one in the Y fabric, yet only 40 total switches are used. Prior art techniques that yield low latency and use identical fabrics for redundancy would have required 54 switches for two fabrics of a Clos network, and 48 switches for two fabrics of a 4-ary 2-cube. It should be noted, however, that the Clos network would have had a non-blocking architecture for any traffic pattern, whereas the present approach is not free of congestion and blocking. We will show below, that the present teachings can also be used to design crossbar-only interconnects, which are both non-blocking and congestion-free, as well as exhibiting lower latency than Clos networks.

It is further illustrative to consider the routing of packets within the physical network topology of FIG. 14. Under normal circumstances, when all the links and switches are functional, a packet from one endpoint to another, traveling along a shortest path between those endpoints, will need to traverse an inter-class router at most once. This is so because the design of FIG. 6, and indeed any design created in accordance with the principles of the present teachings, guarantees that every pair of classes is directly connected in some group. Thus, the shortest path between any pair of endpoints does not traverse the routers of more than one group. Due to this characteristic of routing in the topologies designed in accordance with the present teachings, routing domains exist within each fabric that obviate (and could preclude) the routing of packets between inter-class routers through a class router. In that sense, the present teachings specify a systematic method of creating multiple routing domains within one or more fabrics. Viewed another way, the present teachings also specify a systematic method of creating congestion domains within one or more fabrics. In particular, every group specified by the BIBD, and translated into a portion of a physical network topology in accordance with the principles of intra-class and inter-class connectivity outlined above, corresponds to both a routing domain and a congestion domain within the fabric that contains that group.

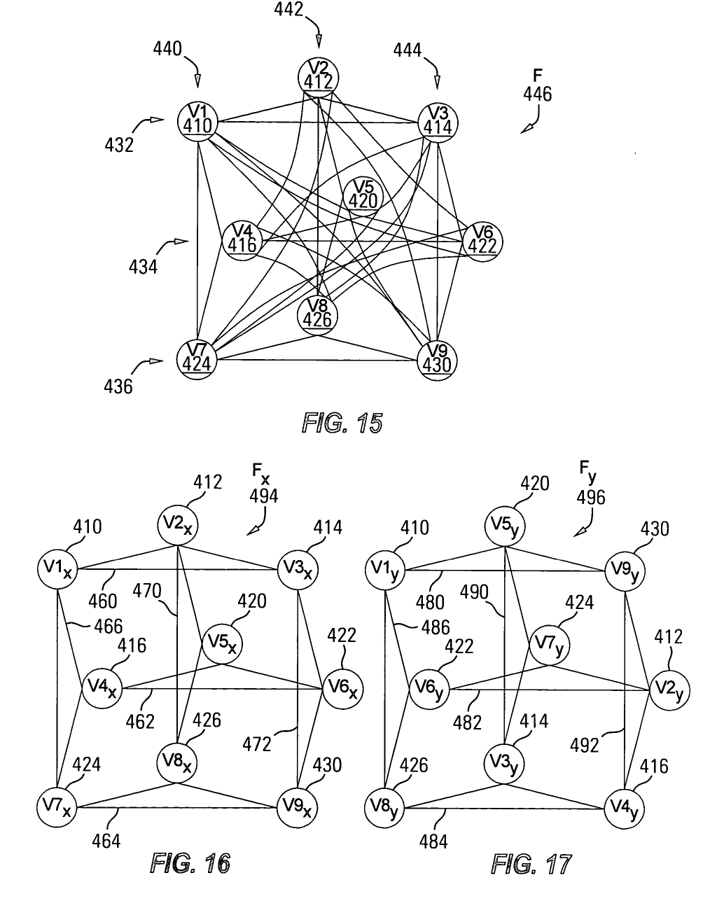

To further illustrate other general properties of the present approach, a 2-(9,3,1)=12 BIBD design will now be described. In this design, 12 groups are needed to connect nine elements, arranged in groups of 3, such that each pair of elements appears in only one group. Referring now to FIG. 15, in the present case the nine groups of the BIBD are nine nodes of a network, V1 410, V2 412, V3 414, V4 416, V5 420, V6 422, V7 424, V8 426 and V9 430. These nine nodes 410-430 can be drawn as shown in FIG. 15. In particular, the nine nodes 410-430 can be drawn as a grid of nodes generally arranged in three rows 432, 434 and 436 and three columns 440, 442 and 444. As part of this design, note that each node (e.g., 410) is directly connected to every other node (e.g., 430). For example, node V1 410 is connected to each of nodes V2-V9 412-430. Where the nine elements are nodes V1-V9 410-430, the 12 groups are therefore the node-to-node connections of the fabric, F 446:

$$F \to \{ \begin{matrix}\{ V1 , V2 , V3 \} , \\ \{ V4 , V5 , V6 \} , \\ \{ V7 , V8 , V9 \} \\ \{ V1 , V4 , V7 \} , \\ \{ V2 , V5 , V8 \} , \\ \{ V3 , V6 , V9 \} \\ \{ V1 , V5 , V9 \} \\ \{ V2 , V6 , V7 \} \\ \{ V3 , V4 , V8 \} \\ \{ V1 , V6 , V8 \} \\ \{ V2 , V4 , V9 \} \\ \{ V3 , V5 , V7 \}\end{matrix} \} .$$

These inter-node connections are shown in FIGS. 15, 16, and 17. Inter-node connection 460 connects nodes V1 410, V2 412 and V3 414. Inter-node connection 462 connects nodes V4 416, V5 420 and V6 422. Inter-node connection 464 connects nodes V7 424, V8 426 and V9 430. Inter-node connection 466 connects nodes V1 410, V4 416 and V7 424. Inter-node connection 470 connects nodes V2 412, V5 420 and V8 426. Inter-node connection 472 connects nodes V3 414, V6 422 and V9 430. Inter-node connection 480 connects nodes V1 410, V5 420 and V9 430. Inter-node connection 482 connects nodes V6 422, V7 424 and V2 412. Inter-node connection 484 connects nodes V8 426, V3 414 and V4 416. Inter-node connection 486 connects nodes V1 410, V6 422 and V8 426. Inter-node connection 490 connects nodes V5 420, V7 424 and V3 414. Finally, inter-node connection 492 connects nodes V9 430, V2 412 and V4 416. To clarify the numerous inter-node connections shown in FIG. 15 as much as possible, inter-node connections in the X fabric are shown with straight lines and laid out as in FIG. 16, inter-node connections in the Y fabric are shown with curved lines, and each inter-node connection contacts the circle indicating a node at a single unique point. Element numbers for inter-node connections are shown in FIGS. 16 and 17 but are left off in FIG. 15.

This collection of inter-node connections can therefore be considered a fabric, F. Notably, the fabric F can be partitioned into two partial fabrics to be called X fabric, F_{X} 494 (FIG. 16) and Y fabric, F_{Y} 496 (FIG. 17). In particular we note the following partitioning of the fabric, F:

$${F}_{X} \to \{ \begin{matrix}\{ V1 , V2 , V3 \} , \\ \{ V4 , V5 , V6 \} , \\ \{ V7 , V8 , V9 \} \\ \{ V1 , V4 , V7 \} , \\ \{ V2 , V5 , V8 \} , \\ \{ V3 , V6 , V9 \}\end{matrix} \}$$

$${F}_{Y} \to \{ \begin{matrix}\{ V1 , V5 , V9 \} \\ \{ V2 , V6 , V7 \} \\ \{ V3 , V4 , V8 \} \\ \{ V1 , V6 , V8 \} \\ \{ V2 , V4 , V9 \} \\ \{ V3 , V5 , V7 \}\end{matrix} \} .$$

Thus, the union of F_{X} and F_{Y} provides for the fabric F=F_{X}∪F_{Y}.

As shown in FIG. 15, a partial grid of fabrics exists that connect nodes V1-V9 410-430 in a first horizontal and vertical pattern as shown. In one instance this configuration is called an X fabric, F_{X} 494 as shown in FIG. 16. With regard to FIG. 15, diagonal connections exist that serially connect nodes V1-V9 410-430 also. This diagonal pattern can be reorganized in the form of a grid with vertical and horizontal connections called a Y fabric, F_{Y} 496, with similar connections as shown in FIG. 17. Accordingly, the collection of fabrics, F 446, as shown in FIG. 15, can be redrawn as the union of two fabrics, F_{X} 494 and F_{Y} 496 (i.e., F=F_{X}∪F_{Y}) as shown in FIGS. 16 and 17, respectively.

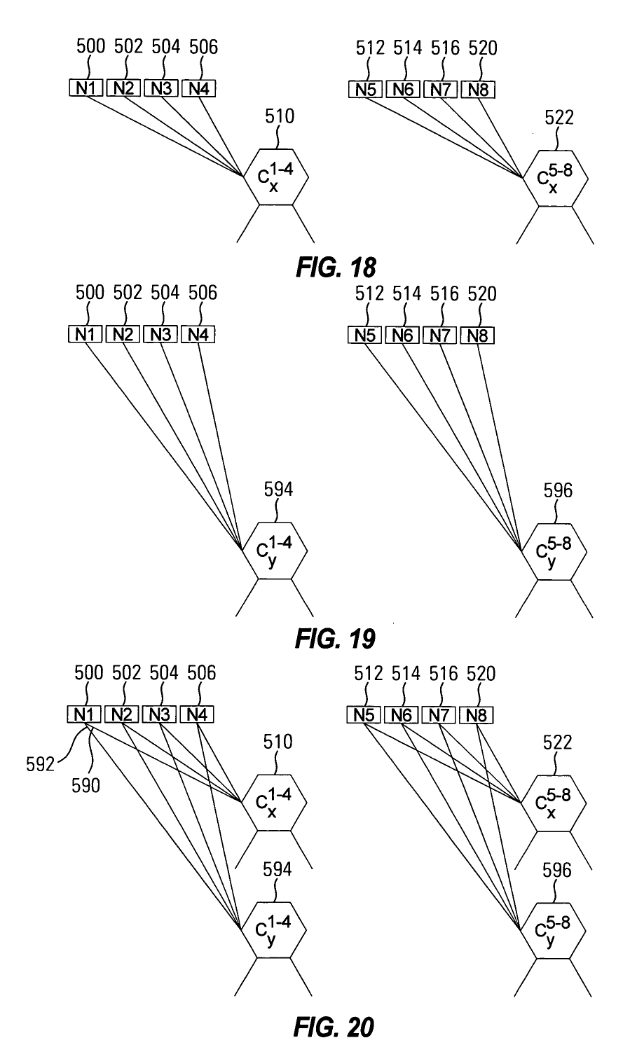

As discussed previously, an equivalence class is a group of similarly connected nodes or endpoints which, for clarity of the discussion, we will again call endpoints while using the term “node” for the various nodes V1-V9. As shown in FIG. 18, four endpoints, N₁ 500, N₂ 502, N₃ 504 and N₄ 506, are connected to a 4-in-2-out switch C_{X}¹⁻⁴ 510. Similarly, four endpoints, N₅ 512, N₆ 514, N₇ 516 and N₈ 520, are connected to a 4-in-2-out switch C_{X}⁵⁻⁸ 522. Here, the collection of 8 endpoints 500-506 and 512-520 can be considered as an equivalence class of nodes connected to a node (for example, node V1 410 of FIG. 16). The following notation, therefore describes the above connections for the X fabric connections of node V1 410:

V1_{X} [symbol] {C_{X}¹⁻⁴(N₁, N₂, N₃, N₄), C_{X}⁵⁻⁸(N₅, N₆, N₇, N₈)}

Each collection of four nodes 500-506 and 512-520 mentioned above is considered a sub-class of nodes. Of course, in other embodiments what is a sub-class here can be considered a class in itself.

With regard to the switches, C_{X}¹⁻⁴ 510 and C_{X}⁵⁻⁸ 522, they are associated with the X fabric, F_{X} 494, shown in FIG. 16. Accordingly, where such switches are associated with the X fabric connections of node V1 410, for example, each switch then connects to the X fabric connections of nodes V2 412 and V3 414, according to the diagram. This same type of configuration can be used for each node of the fabric F_{X} 494 such that:

V2_{X} [symbol] {C_{X}⁹⁻¹²(N₉, N₁₀, N₁₁, N₁₂), C_{X}¹³⁻¹⁶(N₁₃, N₁₄, N₁₅, N₁₆)}

V3_{X} [symbol] {C_{X}¹⁷⁻²⁰(N₁₇, N₁₈, N₁₉, N₂₀), C_{X}²¹⁻²⁴(N₂₁, N₂₂, N₂₃, N₂₄)}

V4_{X} [symbol] {C_{X}²⁵⁻²⁸(N₂₅, N₂₆, N₂₇, N₂₈), C_{X}²⁹⁻³²(N₂₉, N₃₀, N₃₁, N₃₂)}

V5_{X} [symbol] {C_{X}³³⁻³⁶(N₃₃, N₃₄, N₃₅, N₃₆), C_{X}³⁷⁻⁴⁰(N₃₇, N₃₈, N₃₉, N₄₀)}

V6_{X} [symbol] {C_{X}⁴¹⁻⁴⁴(N₄₁, N₄₂, N₄₃, N₄₄), C_{X}⁴⁵⁻⁴⁸(N₄₅, N₄₆, N₄₇, N₄₈)}

V7_{X} [symbol] {C_{X}⁴⁹⁻⁵²(N₄₉, N₅₀, N₅₁, N₅₂), C_{X}⁵³⁻⁵⁶(N₅₃, N₅₄, N₅₅, N₅₆)}

V8_{X} [symbol] {C_{X}⁵⁷⁻⁶⁰(N₅₇, N₅₈, N₅₉, N₆₀), C_{X}⁶¹⁻⁶⁴(N₆₁, N₆₂, N₆₃, N₆₄)}

V9_{X} [symbol] {C_{X}⁶⁵⁻⁶⁸(N₆₅, N₆₆, N₆₇, N₆₈), C_{X}⁶⁹⁻⁷²(N₆₉, N₇₀, N₇₁, N₇₂)}

A full implementation of the fabric F_{X} 494 can then be configured as shown in FIG. 21. For clarity of presentation, only the endpoints of node V1_{X} are shown, however, it should be understood that every other node is similarly connected to respective endpoints. Thus, the equivalence class of endpoints 9-12 and 13-16 (not shown) are connected to node V2_{X} 412 by switches C_{X}⁹⁻¹² 530 and C_{X}¹³⁻¹⁶ 532. The equivalence class of endpoints 17-20 and 21-24 (not shown) are connected to node V3_{X} 414 by switches C_{X}¹⁷⁻²⁰ 534 and C_{X}²¹⁻²⁴ 536. The equivalence class of endpoints 25-28 and 29-32 (not shown) are connected to node V4_{X} 416 by switches C_{X}²⁵⁻²⁸ 540 and C_{X}²⁹⁻³² 542. The equivalence class of endpoints 33-36 and 37-40 (not shown) are connected to node V5_{X} 420 by switches C_{X}³³⁻³⁶ 544 and C_{X}³⁷⁻⁴⁰ 546. The equivalence class of endpoints 41-44 and 45-48 (not shown) are connected to node V6_{X} 422 by switches C_{X}⁴¹⁻⁴⁴ 550 and C_{X}⁴⁵⁻⁴⁸ 552. The equivalence class of endpoints 49-52 and 53-56 shown) are connected to node V7_{X} 424 by switches C_{X}⁴⁹⁻⁵² 554 and C_{X}⁵³⁻⁵⁶ 556. The equivalence class of endpoints 57-60 and 61-64 (not shown) are connected to node V8_{X} 426 by switches C_{X}⁵⁷⁻⁶⁰ 560 and C_{X}⁶¹⁻⁶⁴ 562. Finally, the equivalence class of endpoints 65-68 and 69-72 (not shown) are connected to node V9_{X} 430 by switches C_{X}⁶⁵⁻⁶⁸ 564 and C_{X}⁶⁹⁻⁷² 566.

In implementing the fabric F_{X} 494 of FIG. 21, inter-node connectivity is provided by 6-port routers in accordance with the grid connection:

E_{X}(V1, V2, V3) 570,

E_{X}(V4, V5, V6) 572,

E_{X}(V7, V8, V9) 574,

E_{X}(V1, V4, V7) 576,

E_{X}(V2, V5, V8) 580, and

E_{X}(V3, V6, V9) 582.

Note that the subscript denotes the fabric and the argument denotes the node-to-node connections. These 6-port routers 570-582 allow for 2-port connectivity to three nodes (e.g., node V1 410 to V2 412 to V3 414, etc.).

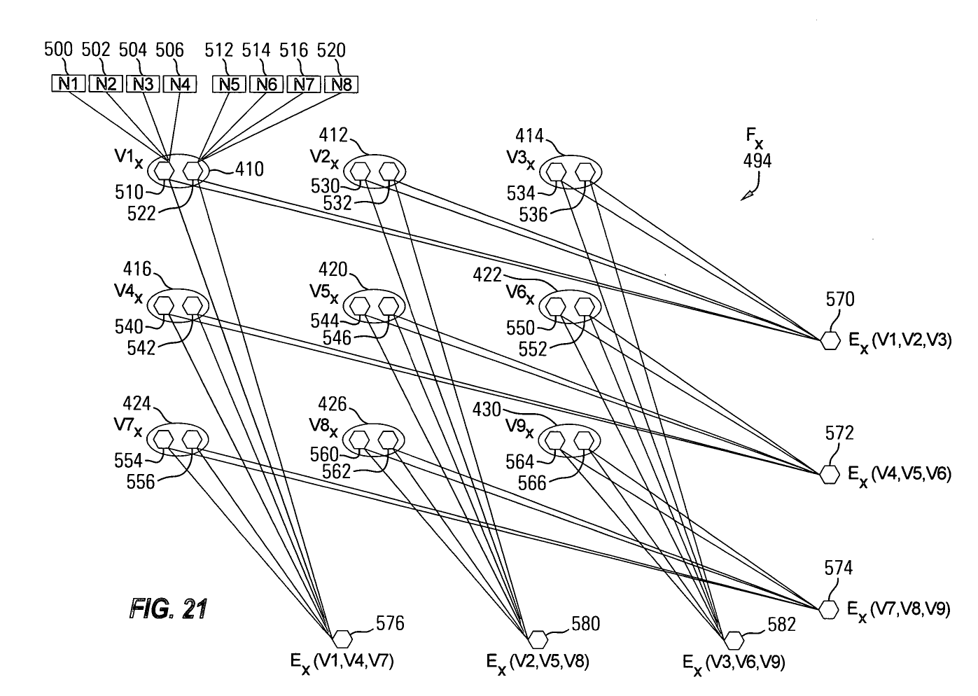

In the same manner that the X fabric, F_{X} 494, is configured, the Y fabric 496 may similarly be configured. With reference to FIG. 19, the similarities to FIG. 18 are evident. In particular, note that the endpoints 500-506 and 512-520 of FIG. 19 are the same as those of FIG. 18. That is, each endpoint (e.g., 500) has two ports (e.g., 590 and 592, FIG. 20), one 590 for communication on the X fabric F_{X} 494 and one 592 for communication on the Y fabric, F_{Y} 496.

Switches C_{Y}¹⁻⁴ 594 and C_{Y}⁵⁻⁸ 596 of FIG. 20, however, are distinct from those 510 and 522 of FIG. 18 in that they are associated with the Y fabric, F_{Y} 496, specifically with the Y fabric connections of node V1 410. The following notation, therefore describes the above connections for the Y fabric connections of node V1:

V1_{Y} [symbol] {C_{Y}¹⁻⁴(N₁, N₂, N₃, N₄), C_{Y}⁵⁻⁸(N₅, N₆, N₇, N₈)}

This same type of configuration can be used for each of nodes of the fabric F_{Y} 496 such that:

V2_{Y} [symbol] {C_{Y}⁹⁻¹²(N₉, N₁₀, N₁₁, N₁₂), C_{Y}¹³⁻¹⁶(N₁₃, N₁₄, N₁₅, N₁₆)}

V3_{Y} [symbol] {C_{Y}¹⁷⁻²⁰(N₁₇, N₁₈, N₁₉, N₂₀), C_{Y}²¹⁻²⁴(N₂₁, N₂₂, N₂₃, N₂₄)}

V4_{Y} [symbol] {C_{Y}²⁵⁻²⁸(N₂₅, N₂₆, N₂₇, N₂₈), C_{Y}²⁹⁻³²(N₂₉, N₃₀, N₃₁, N₃₂)}

V5_{Y} [symbol] {C_{Y}³³⁻³⁶(N₃₃, N₃₄, N₃₅, N₃₆), C_{Y}³⁷⁻⁴⁰(N₃₇, N₃₈, N₃₉, N₄₀)}

V6_{Y} [symbol] {C_{Y}⁴¹⁻⁴⁴(N₄₁, N₄₂, N₄₃, N₄₄), C_{Y}⁴⁵⁻⁴⁸(N₄₅, N₄₆, N₄₇, N₄₈)}

V7_{Y} [symbol] {C_{Y}⁴⁹⁻⁵²(N₄₉, N₅₀, N₅₁, N₅₂), C_{Y}⁵³⁻⁵⁶(N₅₃, N₅₄, N₅₅, N₅₆)}

V8_{Y} [symbol] {C_{Y}⁵⁷⁻⁶⁰(N₅₇, N₅₈, N₅₉, N₆₀), C_{Y}⁶¹⁻⁶⁴(N₆₁, N₆₂, N₆₃, N₆₄)}

V9_{Y} [symbol] {C_{Y}⁶⁵⁻⁶⁸(N₆₅, N₆₆, N₆₇, N₆₈), C_{Y}⁶⁹⁻⁷²(N₆₉, N₇₀, N₇₁, N₇₂)}.

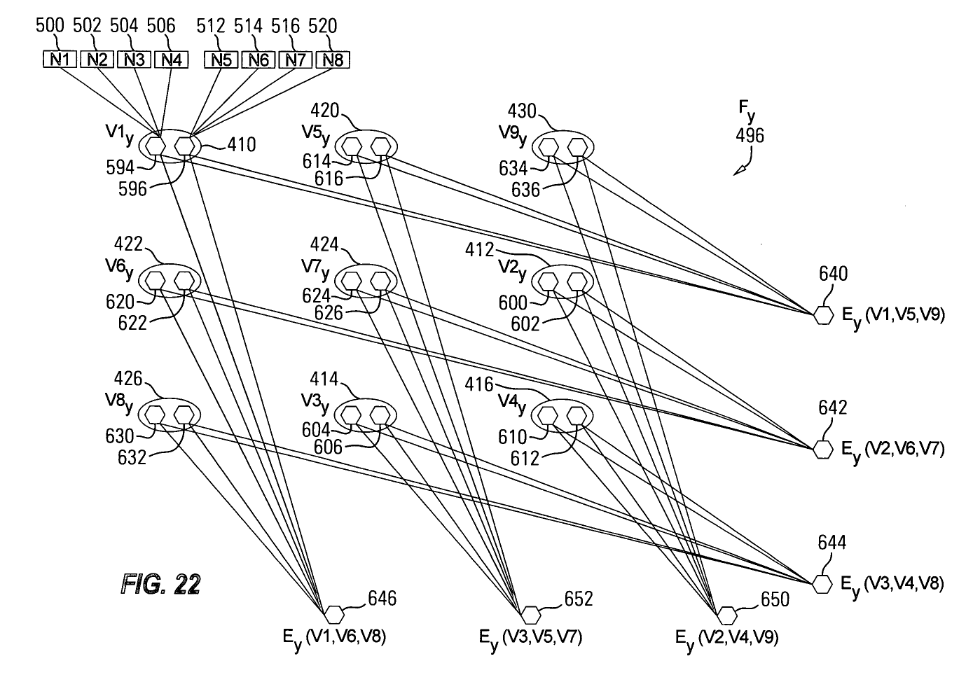

With reference now to FIG. 22, the similarities to FIG. 21 are again evident. In FIG. 22, however, the node-to-node connections are in accordance with the Y fabric, F_{Y} 496, configuration. Again, for clarity of presentation, only the endpoints of node V1_{Y} are shown, however, it should be understood that every other node is similarly connected to respective endpoints. Thus, the equivalence class of endpoints 9-12 and 13-16 (not shown) are connected to node V2_{Y} 412 by switches C_{Y}⁹⁻¹² 600 and C_{Y}¹³⁻¹⁶ 602. The equivalence class of endpoints 17-20 and 21-24 (not shown) are connected to node V3_{Y} 414 by switches C_{Y}¹⁷⁻²⁰ 604 and C_{Y}²¹⁻²⁴ 606. The equivalence class of endpoints 25-28 and 29-32 (not shown) are connected to node V4_{Y} 416 by switches C_{Y}²⁵⁻²⁸ 610 and C_{Y}²⁹⁻³² 612. The equivalence class of endpoints 33-36 and 37-40 (not shown) are connected to node V5_{Y} 420 by switches C_{Y}³³⁻³⁶ 614 and C_{Y}³⁷⁻⁴⁰ 616. The equivalence class of endpoints 41-44 and 45-48 (not shown) are connected to node V6_{Y} 422 by switches C_{Y}⁴¹⁻⁴⁴ 620 and C_{Y}⁴⁵⁻⁴⁸ 622. The equivalence class of endpoints 49-52 and 53-56 (not shown) are connected to node V7_{Y} 424 by switches C_{Y}⁴⁹⁻⁵² 624 and C_{Y}⁵³⁻⁵⁶ 626. The equivalence class of endpoints 57-60 and 61-64 (not shown) are connected to node V8_{Y} 426 by switches C_{Y}⁵⁷⁻⁶⁰ 630 and C_{Y}⁶¹⁻⁶⁴ 632. Finally, the equivalence class of endpoints 65-68 and 69-72 (not shown) are connected to node V9_{Y} 430 by switches C_{Y}⁶⁵⁻⁶⁸ 634 and C_{Y}⁶⁹⁻⁷² 636.

Here, inter-node connectivity is provided by 6-port routers with different connections:

E_{Y}(V1, V5, V9) 640,

E_{Y}(V2, V6, V7) 642,

E_{Y}(V3, V4, V8) 644,

E_{Y}(V1, V6, V8) 646,

E_{Y}(V2, V4, V9) 650, and

E_{Y}(V3, V5, V7) 652.

Note that, here, the node-to-node connections produce the reorganized grid configuration of FIG. 17. Thus, FIGS. 21 and 22 depict the fabrics F_{X} 494 and F_{Y} 496, respectively.

As previously discussed, the union of the two fabrics 494 and 496 composes the complete fabric 446, F=F_{X}∪F_{Y} such that:

V1=V1_{X}∪V1_{Y}

V1 [symbol] {C_{X}¹⁻⁴(N₁, N₂, N₃, N₄), C_{X}⁵⁻⁸(N₅, N₆, N₇, N₈)}∪{C_{Y}¹⁻⁴(N₁, N₂, N₃, N₄), C_{Y}⁵⁻⁸(N₅, N₆, N₇, N₈)}

V2=V2_{X}∪V2_{Y}

V2 [symbol] {C_{X}⁹⁻¹²(N₉, N₁₀, N₁₁, N₁₂), C_{X}¹³⁻¹⁶(N₁₃, N₁₄, N₁₅, N₁₆)}∪{C_{Y}⁹⁻¹²(N₉, N₁₀, N₁₁, N₁₂), C_{Y}¹³⁻¹⁶(N₁₃, N₁₄, N₁₅, N₁₆)}

V3=V3_{X}∪V3_{Y}

V3 [symbol] {C_{X}¹⁷⁻²⁰(N₁₇, N₁₈, N₁₉, N₂₀), C_{X}²¹⁻²⁴(N₂₁, N₂₂, N₂₃, N₂₄)}∪{C_{Y}¹⁷⁻²⁰(N₁₇, N₁₈, N₁₉, N₂₀), C_{Y}²¹⁻²⁴(N₂₁, N₂₂, N₂₃, N₂₄)}

V4=V4_{X}∪V4_{Y}

V4 [symbol] {C_{X}²⁵⁻²⁸(N₂₅, N₂₆, N₂₇, N₂₈), C_{X}²⁹⁻³²(N₂₉, N₃₀, N₃₁, N₃₂)}∪{C_{Y}²⁵⁻²⁸(N₂₅, N₂₆, N₂₇, N₂₈), C_{Y}²⁹⁻³²(N₂₉, N₃₀, N₃₁, N₃₂)}

V5=V5_{X}∪V5_{Y}

V5 [symbol] {C_{X}³³⁻³⁶(N₃₃, N₃₄, N₃₅, N₃₆), C_{X}³⁷⁻⁴⁰(N₃₇, N₃₈, N₃₉, N₄₀)}∪{C_{Y}³³⁻³⁶(N₃₃, N₃₄, N₃₅, N₃₆), C_{Y}³⁷⁻⁴⁰(N₃₇, N₃₈, N₃₉, N₄₀)}

V6=V6_{X}∪V6_{Y}

V6 [symbol] {C_{X}⁴¹⁻⁴⁴(N₄₁, N₄₂, N₄₃, N₄₄), C_{X}⁴⁵⁻⁴⁸(N₄₅, N₄₆, N₄₇, N₄₈)}∪{C_{Y}⁴¹⁻⁴⁴(N₄₁, N₄₂, N₄₃, N₄₄), C_{Y}⁴⁵⁻⁴⁸(N₄₅, N₄₆, N₄₇, N₄₈)}

V7=V7_{X}∪V7_{Y}

V7 [symbol] {C_{X}⁴⁹⁻⁵²(N₄₉, N₅₀, N₅₁, N₅₂), C_{X}⁵³⁻⁵⁶(N₅₃, N₅₄, N₅₅, N₅₆)}∪{C_{Y}⁴⁹⁻⁵²(N₄₉, N₅₀, N₅₁, N₅₂), C_{Y}⁵³⁻⁵⁶(N₅₃, N₅₄, N₅₅, N₅₆)}

V8=V8_{X}∪V8_{Y}

V8 [symbol] {C_{X}⁵⁷⁻⁶⁰(N₅₇, N₅₈, N₅₉, N₆₀), C_{X}⁶¹⁻⁶⁴(N₆₁, N₆₂, N₆₃, N₆₄)}∪{C_{Y}⁵⁷⁻⁶⁰(N₅₇, N₅₈, N₅₉, N₆₀), C_{Y}⁶¹⁻⁶⁴(N₆₁, N₆₂, N₆₃, N₆₄)}

V9=V9_{X}∪V9_{Y}

V9 [symbol] {C_{X}⁶⁵⁻⁶⁸(N₆₅, N₆₆, N₆₇, N₆₈), C_{X}⁶⁹⁻⁷²(N₆₉, N₇₀, N₇₁, N₇₂)}∪{C_{Y}⁶⁵⁻⁶⁸(N₆₅, N₆₆, N₆₇, N₆₈), C_{Y}⁶⁹⁻⁷²(N₆₉, N₇₀, N₇₁, N₇₂)}.

FIG. 20 shows the connectivity of node V1 410. The connectivity between the nodes can be inferred from superposition of FIGS. 21 and 22. Whereas the fabric, F 446, of FIG. 15 was quite complex, a full implementation of the network design just described is even more complex such that a drawing is not provided. Nonetheless, the fabric F 446 allows for complete inter-node connectivity, in that every node can directly communicate with every other node. It should be noted, however, that in other embodiments, inter-node connectivity may be provided by way of an intermediate node, router, switch, or endpoint. The fabric F 446 provides for intra-class connectivity, that is, every endpoint within a class can communicate with another endpoint of the same class. More particularly, intra-sub-class connectivity is provided by the 4-in-2-out switches and inter-sub-class connectivity within the same class is provided by the 6-port routers. Of course, inter-class connectivity is provided by inter-node connectivity. We therefore achieve the desirable result that every endpoint is communicatively coupled to every other endpoint. For connecting 72 nodes using 6-port crossbar switches, the topology of FIGS. 15 through 22 uses a total of 48 switches. This includes 4 switches as shown in FIG. 20 in order to implement each of the 9 classes, and 12 additional switches as shown in FIGS. 21 and 22 to implement inter-node connectivity implied by FIG. 15. The present approach also satisfies some highly desirable properties. For example, such a design exhibits low latency. Here, there are 3 or fewer switches on the best path between any pair of endpoints. A prior art approach, such as MINs, Clos networks and k-ary n-cubes, would have put 5 switches on the best path for certain node pairs. Considering that the delay of many computer operations is proportional to the round-trip time through the network, the present teachings result in 40% savings for certain latency-critical operations. The present approach also exhibits desirable redundant connectivity. Here, there are two completely independent paths between any pair of nodes, one in the X fabric 494 and one in the Y fabric 496. The 48 total switches used here are an improvement over the 54 switches for two fabrics of a Clos network. It should be noted, however, that the Clos network would have had a non-blocking architecture for any traffic pattern, whereas the present approach is not free of congestion and blocking. We will show below, that the present teachings can also be used to design crossbar-only interconnects, which are both non-blocking and congestion-free, as well as exhibiting lower latency than Clos networks.

It should also be noted that the two physical fabrics 494 and 496 shown in FIGS. 21 and 22 are indeed 6-ary 2-cubes. Instead of specifying two identical fabrics, as prior art would have done, the present teachings specify two asymmetric fabrics, thereby reducing latency as much as 40%. In that sense, the present teachings also provide a formal method for designing asymmetric fabric interconnects, containing two complete but non-identical fabrics.

In the particular case just described, a 72-endpoint (or 72-node) topology has been implemented using 6-port crossbar switches. Many variations exist for this particular design and for the more general designs of the present approach. Importantly, many of the results of the above-described example can be generalized for broader applicability. For example, the number of endpoints in a class may be varied to create larger or smaller classes; similarly for the sub-classes. Moreover, the configuration of the above described example can be changed to accommodate various types of available hardware. For example, a 4-in-2-out switch was described. Where a different type of switch is available, such as a 3-in-3-out switch, the network design can be modified; similarly, for the described 6-port router. Indeed the design can be optimized to accommodate available hardware.

The above-described example can further be generalized where any inter-node, inter-class, or inter-sub-class connection can be implemented as a network design in accordance with the principles herein. In this way, a large fabric can be a hierarchical collection of various fabrics of different size.

In the two examples described above, drawings were provided that illustrated node-to-node connections, partitioning, as well as partial or complete fabrics. For larger designs, however, drawings become of limited value because of the unwieldy complexity of such network designs. Accordingly, a third example describing a 2-(13, 4, 1)=13 BIBD will be described based on an understanding of the underlying mathematical concepts of BIBDs, but without a graphical representation. In this design, 13 groups are needed to connect 13 elements, arranged in groups of 4, such that a pair of elements appears in each group. In the present case the 13 groups of the BIBD are 13 nodes of a network. Although not necessary, each node is directly connected to every other node. For example, node V1 is connected to each of nodes V2-V13. Where the 13 elements are nodes V1-V13, the 13 groups are therefore the node-to-node connections are therefore the fabric, F:

$$F \to \{ \begin{matrix}{F}_{1} = \{ V1 , V2 , V4 , V10 \} , \\ {F}_{2} = \{ V1 , V3 , V9 , V13 \} , \\ {F}_{3} = \{ V1 , V5 , V6 , V8 \} \\ {F}_{4} = \{ V1 , V7 , V11 , V12 \} , \\ {F}_{5} = \{ V2 , V3 , V5 , V11 \} , \\ {F}_{6} = \{ V3 , V5 , V7 , V9 \} \\ {F}_{7} = \{ V2 , V8 , V12 , V13 \} \\ {F}_{8} = \{ V3 , V4 , V6 , V12 \} \\ {F}_{9} = \{ V3 , V7 , V8 , V10 \} \\ {F}_{10} = \{ V4 , V5 , V7 , V13 \} \\ {F}_{11} = \{ V4 , V8 , V9 , V11 \} \\ {F}_{12} = \{ V5 , V9 , V10 , V12 \} \\ {F}_{13} = \{ V6 , V10 , V11 , V13 \}\end{matrix} \}$$

This collection of inter-node connections can therefore be considered a fabric, F. Whereas the previous two examples were described with further partitioning into X and Y fabrics, the present embodiment being described will use no further partitioning, but will use the natural partitioning of the BIBD design such that, in effect, four fabric interfaces per node and thirteen separate fabrics will be used.

We now turn to what has been referenced above as classes of nodes with five endpoints in a class. Using a 5-in-1-out router, the total of 65 endpoints are organized into 13 classes. The five endpoints, N₁, N₂, N₃, N₄, and N₅, of the first class are connected to four separate 5-in-1-out switches C₁¹⁻⁵ (note that we use similar notation here as before, however, instead of using an X subscript to denote the X fabric, a number, here “1,” is used), C₂¹⁻⁵, C₃¹⁻⁵, and C₄¹⁻⁵. Together, the four switches will allow the first class to connect into the first four fabrics, just as node V1 of the BIBD participates in the first four groups. The remaining twelve classes are similarly structured. The five endpoints, N₆, N₇, N₈, N₉, and N₁₀, of the second class are connected to four 5-in-1-out switches C₁⁶⁻¹⁰, C₂⁶⁻¹⁰, C₃⁶⁻¹⁰, and C₄⁶⁻¹⁰. This arrangement is repeated thirteen times, until we have the five endpoints, N₆₁, N₆₂, N₆₃, N₆₄, and N₆₅, connected to four 5-in-1-out switches C₁⁶¹⁻⁶⁵, C₂⁶¹⁻⁶⁵, C₃⁶¹⁻⁶⁵, and C₄⁶¹⁻⁶⁵. The following notation, above connections for the various fabric connections of the nodes V1 through V13:

$$V1 \to \{ \begin{matrix}{C}_{1}^{1 –5} ( {N}_{1} , {N}_{2} , {N}_{3} , {N}_{4} , {N}_{5} ) , \\ {C}_{2}^{1 –5} ( {N}_{1} , {N}_{2} , {N}_{3} , {N}_{4} , {N}_{5} ) , \\ {C}_{3}^{1 –5} ( {N}_{1} , {N}_{2} , {N}_{3} , {N}_{4} , {N}_{5} ) , \\ {C}_{4}^{1 –5} ( {N}_{1} , {N}_{2} , {N}_{3} , {N}_{4} , {N}_{5} )\end{matrix} \}$$

$$V2 \to \{ \begin{matrix}{C}_{1}^{6 –10} ( {N}_{6} , {N}_{7} , {N}_{8} , {N}_{9} , {N}_{10} ) , \\ {C}_{2}^{6 –10} ( {N}_{6} , {N}_{7} , {N}_{8} , {N}_{9} , {N}_{10} ) , \\ {C}_{3}^{6 –10} ( {N}_{6} , {N}_{7} , {N}_{8} , {N}_{9} , {N}_{10} ) , \\ {C}_{4}^{6 –10} ( {N}_{6} , {N}_{7} , {N}_{8} , {N}_{9} , {N}_{10} )\end{matrix} \}$$

$$V3 \to \{ \begin{matrix}{C}_{1}^{11 –15} ( {N}_{11} , {N}_{12} , {N}_{13} , {N}_{14} , {N}_{15} ) , \\ {C}_{2}^{11 –15} ( {N}_{11} , {N}_{12} , {N}_{13} , {N}_{14} , {N}_{15} ) , \\ {C}_{3}^{11 –15} ( {N}_{11} , {N}_{12} , {N}_{13} , {N}_{14} , {N}_{15} ) , \\ {C}_{4}^{11 –15} ( {N}_{11} , {N}_{12} , {N}_{13} , {N}_{14} , {N}_{15} )\end{matrix} \}$$

$$V4 \to \{ \begin{matrix}{C}_{1}^{16 –20} ( {N}_{16} , {N}_{17} , {N}_{18} , {N}_{19} , {N}_{20} ) , \\ {C}_{2}^{16 –20} ( {N}_{16} , {N}_{17} , {N}_{18} , {N}_{19} , {N}_{20} ) , \\ {C}_{3}^{16 –20} ( {N}_{16} , {N}_{17} , {N}_{18} , {N}_{19} , {N}_{20} ) , \\ {C}_{4}^{16 –20} ( {N}_{16} , {N}_{17} , {N}_{18} , {N}_{19} , {N}_{20} )\end{matrix} \}$$

$$V5 \to \{ \begin{matrix}{C}_{1}^{21 –25} ( {N}_{21} , {N}_{22} , {N}_{23} , {N}_{24} , {N}_{25} ) , \\ {C}_{2}^{21 –25} ( {N}_{21} , {N}_{22} , {N}_{23} , {N}_{24} , {N}_{25} ) , \\ {C}_{3}^{21 –25} ( {N}_{21} , {N}_{22} , {N}_{23} , {N}_{24} , {N}_{25} ) , \\ {C}_{4}^{21 –25} ( {N}_{21} , {N}_{22} , {N}_{23} , {N}_{24} , {N}_{25} )\end{matrix} \}$$

$$V6 \to \{ \begin{matrix}{C}_{1}^{26 –30} ( {N}_{26} , {N}_{27} , {N}_{28} , {N}_{29} , {N}_{30} ) , \\ {C}_{2}^{26 –30} ( {N}_{26} , {N}_{27} , {N}_{28} , {N}_{29} , {N}_{30} ) , \\ {C}_{3}^{26 –30} ( {N}_{26} , {N}_{27} , {N}_{28} , {N}_{29} , {N}_{30} ) , \\ {C}_{4}^{26 –30} ( {N}_{26} , {N}_{27} , {N}_{28} , {N}_{29} , {N}_{30} )\end{matrix} \}$$

$$V7 \to \{ \begin{matrix}{C}_{1}^{31 –35} ( {N}_{31} , {N}_{32} , {N}_{33} , {N}_{34} , {N}_{35} ) , \\ {C}_{2}^{31 –35} ( {N}_{31} , {N}_{32} , {N}_{33} , {N}_{34} , {N}_{35} ) , \\ {C}_{3}^{31 –35} ( {N}_{31} , {N}_{32} , {N}_{33} , {N}_{34} , {N}_{35} ) , \\ {C}_{4}^{31 –35} ( {N}_{31} , {N}_{32} , {N}_{33} , {N}_{34} , {N}_{35} )\end{matrix} \}$$

$$V8 \to \{ \begin{matrix}{C}_{1}^{36 –40} ( {N}_{36} , {N}_{37} , {N}_{38} , {N}_{39} , {N}_{40} ) , \\ {C}_{2}^{36 –40} ( {N}_{36} , {N}_{37} , {N}_{38} , {N}_{39} , {N}_{40} ) , \\ {C}_{3}^{36 –40} ( {N}_{36} , {N}_{37} , {N}_{38} , {N}_{39} , {N}_{40} ) , \\ {C}_{4}^{36 –40} ( {N}_{36} , {N}_{37} , {N}_{38} , {N}_{39} , {N}_{40} )\end{matrix} \}$$

$$V9 \to \{ \begin{matrix}{C}_{1}^{41 –45} ( {N}_{41} , {N}_{42} , {N}_{43} , {N}_{44} , {N}_{45} ) , \\ {C}_{2}^{41 –45} ( {N}_{41} , {N}_{42} , {N}_{43} , {N}_{44} , {N}_{45} ) , \\ {C}_{3}^{41 –45} ( {N}_{41} , {N}_{42} , {N}_{43} , {N}_{44} , {N}_{45} ) , \\ {C}_{4}^{41 –45} ( {N}_{41} , {N}_{42} , {N}_{43} , {N}_{44} , {N}_{45} )\end{matrix} \}$$

$$V10 \to \{ \begin{matrix}{C}_{1}^{46 –50} ( {N}_{46} , {N}_{47} , {N}_{48} , {N}_{49} , {N}_{50} ) , \\ {C}_{2}^{46 –50} ( {N}_{46} , {N}_{47} , {N}_{48} , {N}_{49} , {N}_{50} ) , \\ {C}_{3}^{46 –50} ( {N}_{46} , {N}_{47} , {N}_{48} , {N}_{49} , {N}_{50} ) , \\ {C}_{4}^{46 –50} ( {N}_{46} , {N}_{47} , {N}_{48} , {N}_{49} , {N}_{50} )\end{matrix} \}$$

$$V11 \to \{ \begin{matrix}{C}_{1}^{51 –55} ( {N}_{51} , {N}_{52} , {N}_{53} , {N}_{54} , {N}_{55} ) , \\ {C}_{2}^{51 –55} ( {N}_{51} , {N}_{52} , {N}_{53} , {N}_{54} , {N}_{55} ) , \\ {C}_{3}^{51 –55} ( {N}_{51} , {N}_{52} , {N}_{53} , {N}_{54} , {N}_{55} ) , \\ {C}_{4}^{51 –55} ( {N}_{51} , {N}_{52} , {N}_{53} , {N}_{54} , {N}_{55} )\end{matrix} \}$$

$$V12 \to \{ \begin{matrix}{C}_{1}^{56 –60} ( {N}_{56} , {N}_{57} , {N}_{58} , {N}_{59} , {N}_{60} ) , \\ {C}_{2}^{56 –60} ( {N}_{56} , {N}_{57} , {N}_{58} , {N}_{59} , {N}_{60} ) , \\ {C}_{3}^{56 –60} ( {N}_{56} , {N}_{57} , {N}_{58} , {N}_{59} , {N}_{60} ) , \\ {C}_{4}^{56 –60} ( {N}_{56} , {N}_{57} , {N}_{58} , {N}_{59} , {N}_{60} )\end{matrix} \}$$

$$V13 \to \{ \begin{matrix}{C}_{1}^{61 –65} ( {N}_{61} , {N}_{62} , {N}_{63} , {N}_{64} , {N}_{65} ) , \\ {C}_{2}^{61 –65} ( {N}_{61} , {N}_{62} , {N}_{63} , {N}_{64} , {N}_{65} ) , \\ {C}_{3}^{61 –65} ( {N}_{61} , {N}_{62} , {N}_{63} , {N}_{64} , {N}_{65} ) , \\ {C}_{4}^{61 –65} ( {N}_{61} , {N}_{62} , {N}_{63} , {N}_{64} , {N}_{65} )\end{matrix} \} .$$

In implementing the thirteen fabrics F₁-F₁₃, inter-node connectivity is provided by 6-port routers E₁ to E₁₃ in accordance with the connections:

F₁ [symbol] E₁(C₁¹⁻⁵, C₁⁶⁻¹⁰, C₁¹⁶⁻²⁰, C₁⁴⁶⁻⁵⁰)

corresponding to {V1, V2, V4, V10} discussed above. Similarly, we have

F₂ [symbol] E₂(C₂¹⁻⁵, C₁¹¹⁻¹⁵, C₁⁴¹⁻⁴⁵, C₁⁶¹⁻⁶⁵)

F₃ [symbol] E₃(C₃¹⁻⁵, C₁²¹⁻²⁵, C₁²⁶⁻³⁰, C₁³⁶⁻⁴⁰)

F₄ [symbol] E₄(C₄¹⁻⁵, C₁³¹⁻³⁵, C₁⁵¹⁻⁵⁵, C₁⁵⁶⁻⁶⁰)

F₅ [symbol] E₅(C₂⁶⁻¹⁰, C₂¹¹⁻¹⁵, C₂²¹⁻²⁵, C₂⁵¹⁻⁵⁵)

F₆ [symbol] E₆(C₃⁶⁻¹⁰, C₂²⁶⁻³⁰, C₂³¹⁻³⁵, C₂⁴¹⁻⁴⁵)

F₇ [symbol] E₇(C₄⁶⁻¹⁰, C₂³⁶⁻⁴⁰, C₂⁵⁶⁻⁶⁰, C₂⁶¹⁻⁶⁵)

F₈ [symbol] E₈(C₄¹¹⁻¹⁵, C₂¹⁶⁻²⁰, C₃²⁶⁻³⁰, C₃⁵⁶⁻⁶⁰)

F₉ [symbol] E₉(C₅¹¹⁻¹⁵, C₃³¹⁻³⁵, C₃³⁶⁻⁴⁰, C₂⁴⁶⁻⁵⁰)

F₁₀ [symbol] E₁₀(C₃¹⁶⁻²⁰, C₃²¹⁻²⁵, C₄³¹⁻³⁵, C₃⁶¹⁻⁶⁵)

F₁₁ [symbol] E₁₁(C₄¹⁶⁻²⁰, C₄³⁶⁻⁴⁰, C₃⁴¹⁻⁴⁵, C₃⁵¹⁻⁵⁵)

F₁₂ [symbol] E₁₂(C₄²¹⁻²⁵, C₄⁴¹⁻⁴⁵, C₃⁴⁶⁻⁵⁰, C₄⁵⁶⁻⁶⁰)

F₁₃ [symbol] E₁₃(C₄²⁶⁻³⁰, C₄⁴⁶⁻⁵⁰, C₄⁵¹⁻⁵⁵, C₄⁶¹⁻⁶⁵)

Note that where 6-port routers are used here, only four ports are used in this implementation. Further note that the collection of these 13 partial fabrics, F₁-F₁₃, makes up the complete fabric, F. No attempt is made to depict any one of these fabrics, much less the complete fabric, because of its complexity. Upon understanding the first two embodiments with the accompanying drawings, one of skill in the art will understand that this third embodiment is simply an extension of the previous teachings that can be implemented in a real-world design.

Notably, the fabric F allows for complete inter-node connectivity, where every node can directly communicate with every other node. It should be noted, however, that in other embodiments, inter-node connectivity may be provided by way of an intermediate node, router, switch, or endpoint. The fabric F provides for intra-class connectivity where every endpoint within a class can communicate with another endpoint of the same class. More particularly, intra-sub-class connectivity is provided by the 5-in-1-out switches and inter-sub-class connectivity within the same class is provided by the 6-port routers. Of course, inter-class connectivity is provided by inter-node connectivity. We therefore achieve the desirable result that every endpoint is communicatively coupled to every other endpoint.

In the particular case just described, a 65-endpoint (or 13-node) topology has been implemented using 6-port crossbar switches. Many variations exist for this particular design and for the more general designs of the present disclosure. Importantly, many of the results of the above-described example can be generalized for broader applicability. For example, the number of endpoints in a class can be varied to create larger or smaller classes; similarly for the sub-classes. Moreover, the configuration of the above-described example can be changed to accommodate various types of available hardware. For example, a 4-in-2-out switch was described. Where a different type of switch is available, such as a 3-in-3-out switch, the network design can be modified; similarly, for the described 6-port router. Indeed the design can be optimized to accommodate available hardware.

The above-described example can further be generalized wherein any inter-node, inter-class, or inter-sub-class connection can be implemented as a network design. In this way, a large fabric can be a hierarchical collection of various fabrics of different size.

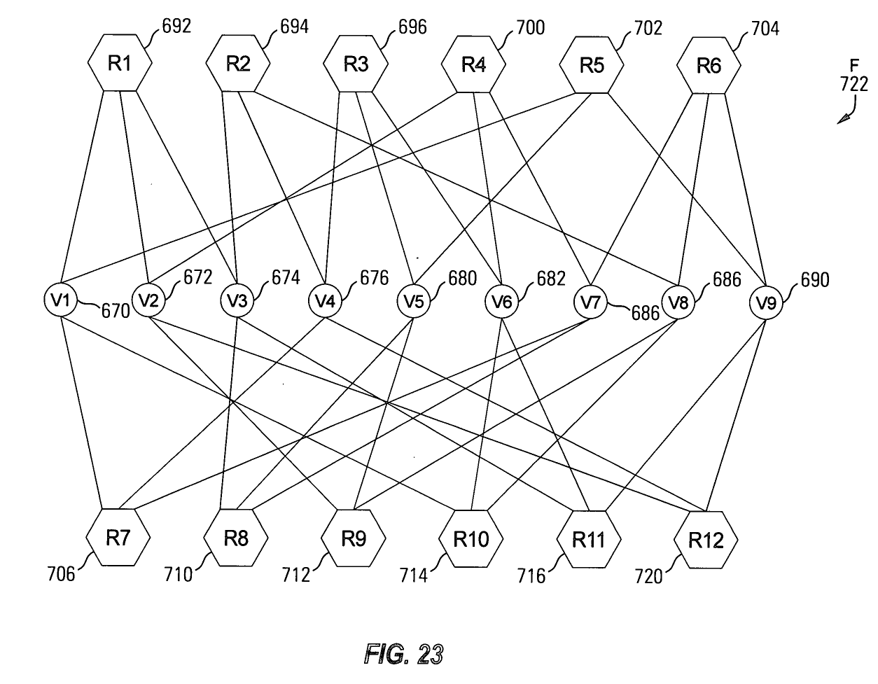

In yet another example, a 2-(9, 3, 1)=12 BIBD is shown in FIG. 23. In this design, 12 groups are needed to connect 9 elements, arranged in groups of 3, such that a pair of elements appears in each group. As shown in FIG. 23, the 9 groups of the BIBD are 9 classes of similarly connected nodes V1 670, V2 672, V3 674, V4 676, V5 680, V6 682, V7 684, V8 686, and V9 690 of a network. Although not necessary, each class of nodes is directly connected to every other node by way of one crossbar switch (equivalently a router) of twelve crossbar switches R1 692, and connected to R2 694, R3 696, R4 700, R5 702, R6 704, R7 706, R8 710, R9 712, R10 714, R11 716 and R12 720. For example, node V1 670 is connected to nodes V2 672 and V3 674 by crossbar switch R1 692, nodes V4 676 and V7 684 by crossbar R7 706; other connections are as shown in FIG. 23. The fabric, F 722, can therefore be described as:

$$F \to \{ \begin{matrix}\{ V1 , V2 , V3 \} , \\ \{ V3 , V4 , V8 \} , \\ \{ V4 , V5 , V6 \} , \\ \{ V2 , V6 , V7 \} , \\ \{ V1 , V5 , V9 \} , \\ \{ V7 , V8 , V9 \} , \\ \{ V1 , V4 , V7 \} , \\ \{ V3 , V5 , V7 \} , \\ \{ V2 , V5 , V8 \} , \\ \{ V1 , V6 , V8 \} , \\ \{ V3 , V6 , V9 \} , \\ \{ V2 , V4 , V9 \}\end{matrix} \} .$$

In proceeding to develop a physical design, the various crossbar switches, R1-R12 692-720, will be implemented as 12-port crossbar switches. With this physical implementation as a consideration, the various nodes V1-V9 670-690 are provided as groups of similarly configured nodes or classes of nodes. More particularly, each class is implemented as four endpoints:

V1 [symbol] {N1, N2, N3, N4}

V2 [symbol] {N5, N6, N7, N8}

V3 [symbol] {N9, N10, N11, N12}

V4 [symbol] {N13, N14, N15, N16}

V5 [symbol] {N17, N18, N19, N20}

V6 [symbol] {N21, N22, N23, N24}

V7 [symbol] {N25, N26, N27, N28}

V8 [symbol] {N29, N30, N31, N32}

V9 [symbol] {N33, N34, N35, N36}.

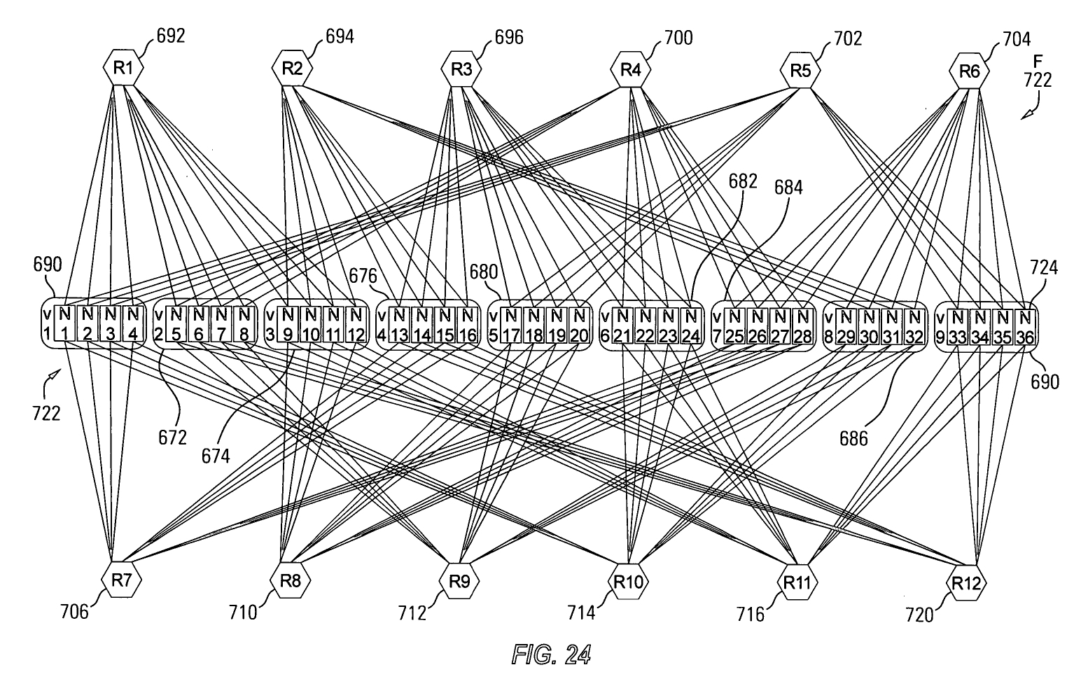

As further shown in FIG. 24, as well as FIG. 23, each endpoint 722 connects to four crossbar switches. For example, endpoint N36 724 connects to crossbar switches R5 702, R6 704, R 11 716 and R12 720. To do this, the various endpoints 722 may utilize dual NICs, where each NIC has two ports, for a total of four ports per endpoint. Where previous examples within the present disclosure described the use of class routers, no class routers are used in the present embodiment because the class router functions are performed by the various NICs of the four endpoints of a class. Accordingly, no further partitioning is necessary.

As noted, 12-port crossbar switches R1-R12 692-720 are used such that each crossbar switch (e.g., R1 692) can connect three nodes (e.g., V1 670, V2 672 and V3 674). By similarly connecting each endpoint of a class according to the fabric, F 722, described above, the network design of FIG. 24 is obtained. Notably, the fabric F 722 allows for complete inter-node and inter-endpoint connectivity, where every node (e.g., 670) can directly communicate with every other node (e.g., 672-690) and every endpoint (e.g., 724) can directly communicate with every other endpoint 722. Whereas here, node-to-node and in turn endpoint-to-endpoint connectivity is provided by crossbar switches, other embodiments are possible that provide inter-node or inter-endpoint connectivity by way of an intermediate node, router, switch, or endpoint. In the present embodiment, it should be noted that the crossbar switches also provide for inter-class (and intra-sub-class) connectivity to achieve the desirable result that every endpoint is communicatively coupled to every other endpoint.

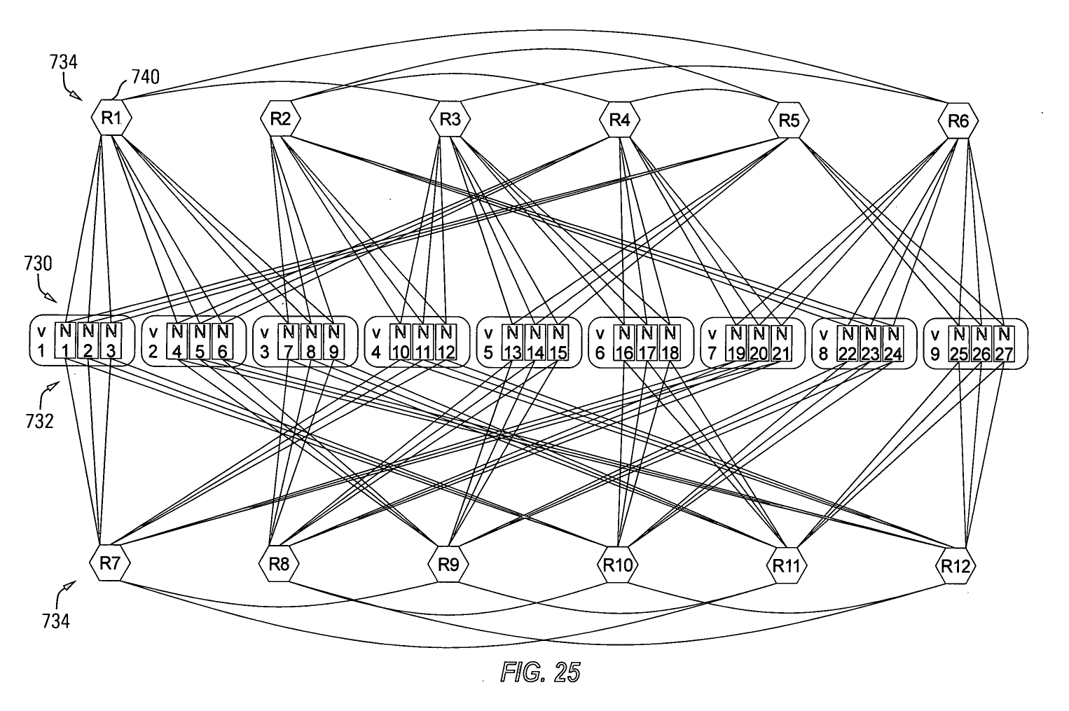

Many variations exist for this particular design and for the more general designs of the present disclosure. Importantly, many of the results of the above-described example may be generalized for broader applicability. For example, the number of endpoints in a class may be varied to create larger or smaller classes; similarly for the sub-classes. Moreover, the configuration of the above-described example may be changed to accommodate various types of available hardware or desired fault tolerance. FIG. 25 provides an example of a fault-tolerant design that is a variation of the 2-(9, 3, 1)=12 design just described. In FIG. 25, note that the nine nodes V1-V9 730 contain three endpoints each 732 as

V1 [symbol] {N1, N2, N3}

V2 [symbol] {N4, N5, N6}

V3 [symbol] {N7, N8, N9}

V4 [symbol] {N10, N11, N12}

V5 [symbol] {N13, N14, N15}

V6 [symbol] {N16, N17, N18}

V7 [symbol] {N19, N20, N21}

V8 [symbol] {N22, N23, N24}

V9 [symbol] {N25, N26, N27}.

Further note that crossbar switches 734 connect the various nodes 730 and endpoints 732 in a manner similar to that of FIG. 24 to provide complete inter-node, inter-class, intra-node, and intra-class connectivity as before. In FIG. 25, however, note that crossbar-to-crossbar connections are provided by two ports (e.g., 736) of each (e.g., 740) of the 12-port crossbar switches 734. While this physical implementation has fewer endpoints 732 than the implementation of FIG. 24, it advantageously provides for a fault-tolerant implementation by providing redundant, although longer, paths between nodes 730 and endpoints 732. In the design of FIG. 25, three of the four inter-node (as opposed to intra-node) paths yields a two-hop contended connection, and one path provides a one-hop contention-free connection, where the latter is the preferred path, but the former provide fault tolerant paths upon a crossbar failure.

The above-described example can further be generalized wherein any inter-node, inter-class, or inter-sub-class connection can be implemented as a network design. In this way, a large fabric can be a hierarchical collection of various fabrics of different size.

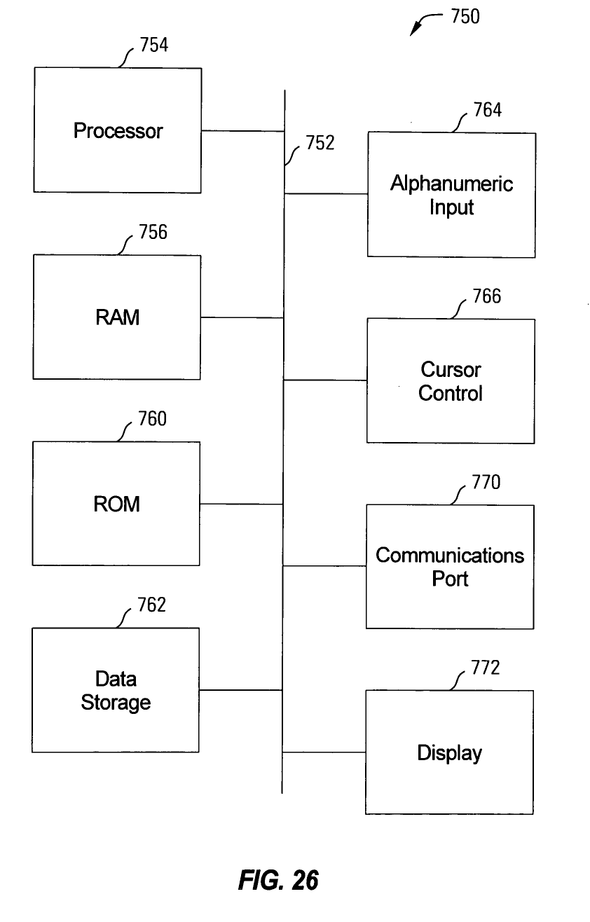

In an embodiment, the present teachings are practiced on a computer system 750 as shown in FIG. 26. Referring to FIG. 26, an exemplary computer system 750 (e.g., personal computer, workstation, mainframe, etc.) upon which the present teachings may be practiced is shown. When configured to practice the present teachings, system 750 becomes a computer aided design (CAD) tool suitable for assisting in designing interconnect systems in large and small scale applications. Computer system 750 is configured with a data bus 752 that communicatively couples various components. As shown in FIG. 26, processor 754 is coupled to bus 752 for processing information and instructions. A computer readable volatile memory such as RAM 756 is also coupled to bus 752 for storing information and instructions for the processor 754. Moreover, computer readable read only memory (ROM) 760 is also coupled to bus 752 for storing static information and instructions for processor 754. A data storage device 762 such as a magnetic or optical disk media is also coupled to bus 752. Data storage device 762 is used for storing large amounts of information and instructions. An alphanumeric input device 764, including alphanumeric and function keys, is coupled to bus 752 for communicating information and command selections to the processor 754. A cursor control device 766 such as a mouse is coupled to bus 752 for communicating user input information and command selections to the central processor 754. Input/output communications port 770 is coupled to bus 752 for communicating with a network, other computers, or other processors, for example. Display 772 is coupled to bus 752 for displaying information to a computer user. Display device 772 may be a liquid crystal device, cathode ray tube, or other display device suitable for creating graphic images and alphanumeric characters recognizable by the user. The alphanumeric input 764 and cursor control device 766 allow the computer user to dynamically signal the two-dimensional movement of a visible symbol (pointer) on display 772.

While various embodiments and advantages have been described, it will be recognized that a number of variations will be readily apparent. For example, in implementing equivalence classes, designs can be scaled to implement networks of many sizes. Moreover, the present teachings can be used to create routing domains or virtual SANs within a larger physical fabric. Thus, the present teachings may be widely applied consistent with the foregoing disclosure and the claims which follow.

What is claimed is:

1. A multi-fabric interconnection system, comprising:
a plurality of first nodes interconnected as a balanced incomplete block design of the form 2-(ν, k, 1)=b, wherein ν first nodes, arranged in b groups of k first nodes, are interconnected such that each pair of first nodes appears in only one group of the b groups, and
a plurality of first forwarding nodes configured to interconnect the plurality of first nodes;
a plurality of sets of second nodes, wherein each second node is connected to one of the first nodes, and wherein each of the second nodes is interconnected to every other second node.

2. The interconnection system of claim 1, wherein each second node is interconnected to other second nodes via at least one first node.

3. The interconnection system of claim 1, wherein each first node includes at least one first switch.

4. The interconnection system of claim 3, wherein each second node in said plurality of sets of second nodes is interconnected to other second nodes via said at least one first switch.

5. The interconnection system of claim 4, wherein each of said plurality of sets of second nodes is interconnected to another of said plurality of sets of second nodes via said at least one first switch.

6. The interconnection system of claim 4, wherein said at least one first switch interconnects one of said plurality of sets of second nodes to another of said plurality of sets of second nodes.

7. The interconnection system of claim 4, wherein said at least one first switch is shared with at least two of said plurality of sets of second nodes.

8. The interconnection system of claim 1, wherein each of said plurality of sets of second nodes is further divided into a plurality of sub-sets of second nodes.

9. The interconnection system of claim 8, wherein said plurality of sub-sets of second nodes in at least one of said plurality of sets of second nodes are interconnected to each other via a second switch.

10. The interconnection system of claim 8, wherein said plurality of sub-sets of second nodes are interconnected to each other via at least one of said at least one first switches within one of said plurality of first nodes.

11. The interconnection system of claim 1, wherein each second node in said plurality of sets of second nodes is configured with at least two communications ports.

12. The interconnection system of claim 1, wherein connections between second nodes in said plurality of sets of second nodes are partitioned into a plurality of incomplete fabrics.

13. The interconnection system of claim 1, wherein at least one of said plurality of first forwarding nodes are chosen from a group consisting of routers, switches, crossbars, optical rings, backplanes, buses, interconnections, and links.

14. The interconnection system of claim 1, wherein each second node in said plurality of sets of second nodes is interconnected to every other second node via at least one of said plurality of first nodes.

15. The interconnection system of claim 8, wherein said plurality of sub-sets of second nodes are interconnected to each other via one of said plurality of first forwarding nodes.

16. A method for configuring a communications network, comprising:
configuring interconnections of a plurality of first nodes as a balanced incomplete block design of the form 2-(ν, k, 1)=b, wherein ν first nodes, arranged in b groups of k first nodes, are interconnected such that a pair of first nodes appears in only one group of the b groups; and
configuring interconnections of a plurality of sets of second nodes to the plurality of first nodes, wherein each second node is interconnected to every other second node.

17. The method of claim 16, further comprising configuring interconnections of each second node in said plurality of sets of second nodes to every other second node via at least one of said plurality of first nodes.

18. The method of claim 16, wherein each of said plurality of first nodes includes at least one switch.

19. The method of claim 18, further comprising configuring interconnections of each second node in said plurality of sets of second nodes to every other second node via said at least one switch.

20. The method of claim 18, wherein said at least one switch interconnects one set of second nodes in said plurality of sets of second nodes to another set of second nodes in said plurality of sets of second nodes.

21. The method of claim 18, wherein at least one of said at least one switches is shared by at least two sets of second nodes in said plurality of sets of second nodes.

22. The method of claim 16, further comprising dividing said plurality of sets of second nodes into a plurality of sub-sets of second nodes.

23. The method of claim 22, further comprising configuring a plurality of first forwarding nodes to interconnect said plurality of first nodes.

24. The method of claim 23, wherein at least one of said plurality of first forwarding nodes is chosen from a group consisting of routers, switches, crossbars, optical rings, backplanes, buses, interconnections, and links.

25. The method of claim 23, further comprising configuring interconnections of each of said plurality of sub-sets of second nodes to other sub-sets of second nodes via one of said plurality of first forwarding nodes.

26. The method of claim 23, further comprising configuring a plurality of second forwarding nodes to interconnect said plurality of sets of second nodes.

27. The method of claim 26, wherein at least one of said plurality of second forwarding nodes is chosen from a group consisting of routers, switches, crossbars, optical rings, backplanes, buses, interconnections, and links.

28. The method of claim 22, further comprising configuring interconnections of each of said plurality of sub-sets of second nodes to other sub-sets of second nodes via a switch within one of said plurality of first nodes.

29. The method of claim 16, wherein each second node in said plurality of sets of second nodes is configured with at least two communications ports.

30. The method of claim 16, further comprising partitioning connections among second nodes in said plurality of sets of second nodes into a plurality of incomplete fabrics.

31. The method of claim 16, wherein each second node in said plurality of sets of second nodes is connected to one of said plurality of first nodes.

32. A method for converting a mathematical design to a physical communications network, comprising:
providing a mathematical representation of a plurality of connected first nodes in the form of a balanced incomplete block design defined as 2-(ν, k, 1)=b, wherein ν first nodes, arranged in b groups of k first nodes, are interconnected such that a pair of first nodes appears in only one group of the b groups;
converting the mathematical representation to a physical design in which a plurality of first forwarding nodes interconnect the plurality of first nodes; and
assigning a plurality of sets of second nodes to one of the first nodes; such that each of the second nodes is interconnected to every other node.

33. The method of claim 32, further comprising interconnecting each second node of said plurality of sets of second nodes to other second nodes via at least one of said plurality of connected first nodes.

34. The method of claim 32, wherein each of said plurality of connected first nodes includes at least one switch.

35. The method of claim 34, further comprising configuring interconnections of each second node of said plurality of sets of second nodes to other second nodes via said at least one switch.

36. The method of claim 34, wherein said at least one switch interconnects one of said plurality of sets of second nodes to another of said plurality of sets of second nodes.

37. The method of claim 34, wherein at least one of said at least one second switches is shared by at least two of said plurality of sets of second nodes.

38. The method of claim 32, further comprising dividing said plurality of sets of second nodes into a plurality of sub-sets of second nodes.

39. The method of claim 38 further comprising configuring interconnections of each of said plurality of sub-sets of second nodes to other sub-sets of second nodes via a switch.

40. The method of claim 39, wherein said switch is within one of said plurality of connected first nodes.

41. The method of claim 32, wherein each second node in said plurality of sets of second nodes is configured with at least two communications ports.

42. The method of claim 32, further comprising partitioning connections among second nodes in said plurality of sets of second nodes into a plurality of incomplete fabrics.

43. The method of claim 32, wherein at least one of said plurality of first forwarding nodes is chosen from a group consisting of routers, switches, crossbars, optical rings, backplanes, buses, interconnections, and links.

44. The method of claim 32, wherein said method is executed recursively.
